(19) United States
(12) Patent Application Publication
(10) Pub. No.: US 2015/0269864 A1
(43) Pub. Date: Sep. 24, 2015

(54) HEALTH CARE SYSTEM

(71) Applicant: LIFE ROBO CORP., Tokyo (JP)

(72) Inventor: Akiyoshi Tanabe, Tokyo (JP)

(21) Appl. No.: 14/351,970

(22) PCT Filed: Oct. 18, 2013
(86) PCT No.: PCT/JP2013/078252

§ 371 Date: Apr. 15, 2014

(30) Foreign Application Priority Data
Jul. 5, 2013 (JP) 2013-141340

(51) Int. Cl. G09B 19/00

(52) U.S. Cl. CPC G09B 19/00

(57) ABSTRACT

An object of the present invention is to increase awareness to health of the user and make the user actively work on improvement in his/her lifestyle habits. A server apparatus 30 extracts record data recorded in a most-recent period T1 from multiple kinds of data of the user in a database apparatus 50, and obtains a moving average deviation by kinds. By analyzing the moving average deviation in accordance with a predetermined algorithm, balance parameters indicating the health conditions of the user as evaluation levels of five kinds of evaluation items of physical strength, anti-aging power, beauty power, awareness level, and continuity are obtained, and a radar chart of the balance parameters is displayed as a body balance screen to a user terminal 10.

### TECHNICAL FIELD

The present invention relates to a technique supporting health maintenance of a human by service provided via a network.

### BACKGROUND ART

Patent Literature 1 is a literature disclosing a technique of this kind. A home health management system disclosed in Patent Literature 1 obtains data related to management of health of members of a family and names and amounts of food ingested by each person by an input device installed in a house. In the system, the nutritional value is computed from the name and amount of food of each person, a disease the person may get is obtained on the basis of the nutritional value, an exercise amount and a food intake necessary to maintain a healthy life are computed, and the information is provided via display means.

### CITATION LIST

### Patent Literature

Patent Literature 1: JP 10-074226 A

### SUMMARY OF INVENTION

### Technical Problem

An effect of preventing a disease, so-called lifestyle disease can be expected to a certain degree by improving daily lifestyle habits. In reality, however, not many people can work on improvement in the lifestyle habits without any support. The home health management system disclosed in Patent Literature 1 merely provides advice related to a disease when health management data of family members and meal data is entered. Consequently, a high effect cannot be expected from the technique of Patent Literature 1 in the case where each of the family members does not have high awareness to health.

The present invention has been achieved in view of such a problem and an object of the invention is to increase awareness to health of the user and make the user actively work on improvement in his/her lifestyle habits.

### Solution to Problem

To solve the above problem, a health care system which is a preferable aspect of the present invention includes a server apparatus and a database apparatus connected to a user terminal of each user via a network, wherein the database apparatus stores a plurality of kinds of record data recorded with respect to a plurality of kinds of record items in the user terminal of the each user, and the server apparatus extracts record data of a plurality of kinds recorded in a most-recent first period in the plurality of kinds of record data of the user in the database apparatus, obtains a moving average deviation by kinds of the extracted plurality of kinds of record data, obtains balance parameters indicating health conditions of the user as evaluation levels of five kinds of evaluation items of physical strength, anti-aging power, beauty power, awareness level, and continuity by analyzing the obtained moving average deviations of the plurality of kinds in accordance with a predetermined algorithm, and displays a screen including the obtained balance parameters as a radar chart in the user terminal.

Many of actions taken for maintaining health by a human have both good and bad aspects. For example, exercise is highly recommended from the aspect of improvement in autonomic nerve and improvement in physical strength. However, excessive exercise oxidizes the body and accelerates aging. In the present invention, the evaluation result of evaluating the health conditions of the user in the five kinds of evaluation items of physical strength, anti-aging power, beauty power, awareness level, and continuity is presented as a radar chart to the user. Therefore, according to the present invention, the user can improve his/her lifestyle habits while paying attention widely to various elements related to his/her health.

Thus, according to the present invention, the awareness to health of the user can be increased to make the user actively work on improvement in his/her lifestyle habits.

### BRIEF DESCRIPTION OF DRAWINGS

FIG. 1 is a general configuration diagram of a health care system as an embodiment of the present invention.

FIG. 2 is a diagram illustrating a hardware schematic configuration of a server apparatus of the system.

FIG. 3 is a diagram illustrating a hardware schematic configuration of a database apparatus of the system.

FIG. 4 is a diagram illustrating an individual setting screen displayed in a user terminal of the system.

FIG. 5 is a diagram illustrating an individual setting screen displayed in a user terminal of the system.

FIG. 6 is a diagram illustrating outline of health care service of the system.

FIG. 7 is a diagram illustrating a weight/body fat percentage input screen displayed in a user terminal of the system.

FIG. 8 is a diagram illustrating a meal/calorie input screen displayed in a user terminal of the system.

FIG. 9 is a diagram illustrating a top screen displayed in a user terminal of the system.

FIG. 10 is a diagram illustrating a body balance screen displayed in a user terminal of the system.

FIG. 11 is a diagram conceptually illustrating a radar chart presentation process in the system.

FIG. 12 is a data structure diagram of a conditions and weight ratio table in the system.

FIG. 13 is a data structure diagram of a conditions and weight ratio table in the system.

FIG. 14 is a diagram conceptually illustrating a process of calculating a recommended sleep time zone cover ratio in the system.

FIG. 15 is a diagram conceptually illustrating a future weight presenting process and a future face presenting process in the system.

FIG. 16 is a diagram illustrating a face picture selecting screen displayed in a user terminal of the system.

FIG. 17 is a flowchart that illustrates steps of the future weight presenting process in the system.

FIG. 18 is a diagram illustrating a condition of whether a future weight can be predicted or not in the system.

FIGS. 19(A) and 19(B) are data structure diagrams of a physical strength coefficient table in the system.

FIGS. 20(A) and 20(B) are data structure diagrams of a basal metabolism coefficient table in the system.

FIG. 21 is a diagram conceptually illustrating a process of making the basal metabolism coefficient act in the system.

FIG. 22 is a diagram illustrating the relations among a body weight value, a target body weight, a standard body weight, and a future body weight presenting process in the system.

FIG. 23 is a flowchart illustrating steps of a future predication face picture presenting process in the system.

FIG. 24 is a data structure diagram of an addition/deletion point value table in the system.

FIG. 25 is a data structure diagram of an aging year value table in the system.

### DESCRIPTION OF EMBODIMENT

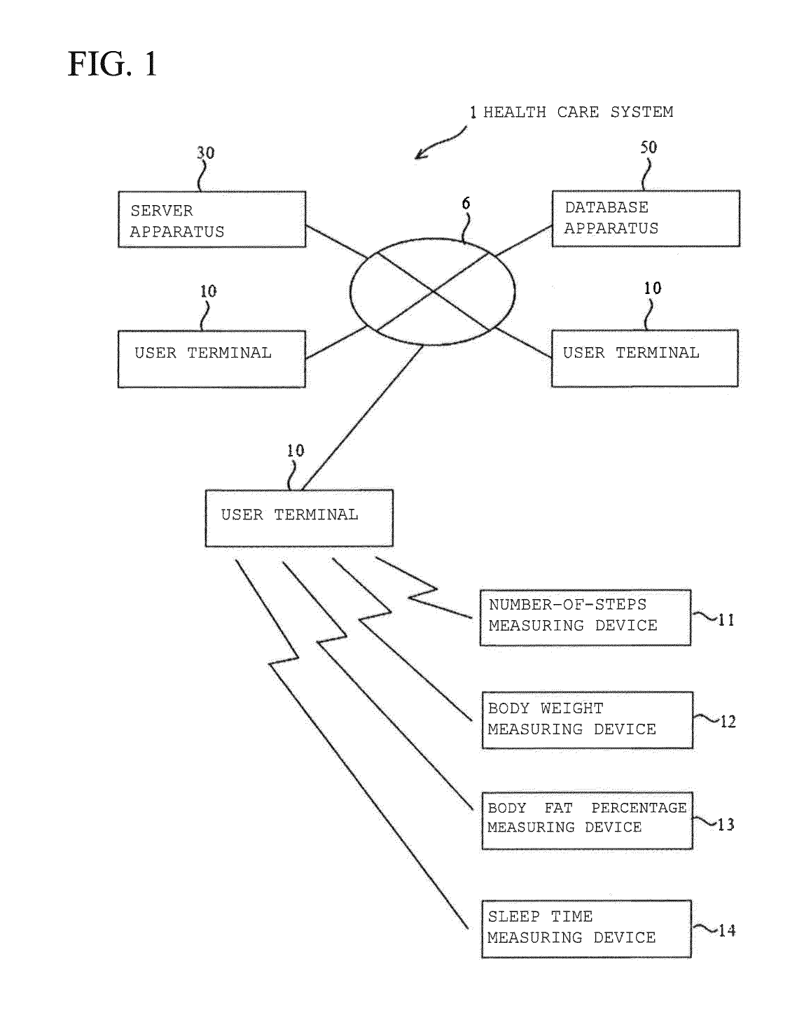

Hereinafter, an embodiment of the present invention will be described with reference to the drawings. FIG. 1 is a system configuration diagram of a health care system 1 as an embodiment of the present invention. As illustrated in FIG. 1, the health care system 1 has user terminals 10, a server apparatus 30, and a database apparatus 50. The user terminal 10 is a smartphone owned by a user.

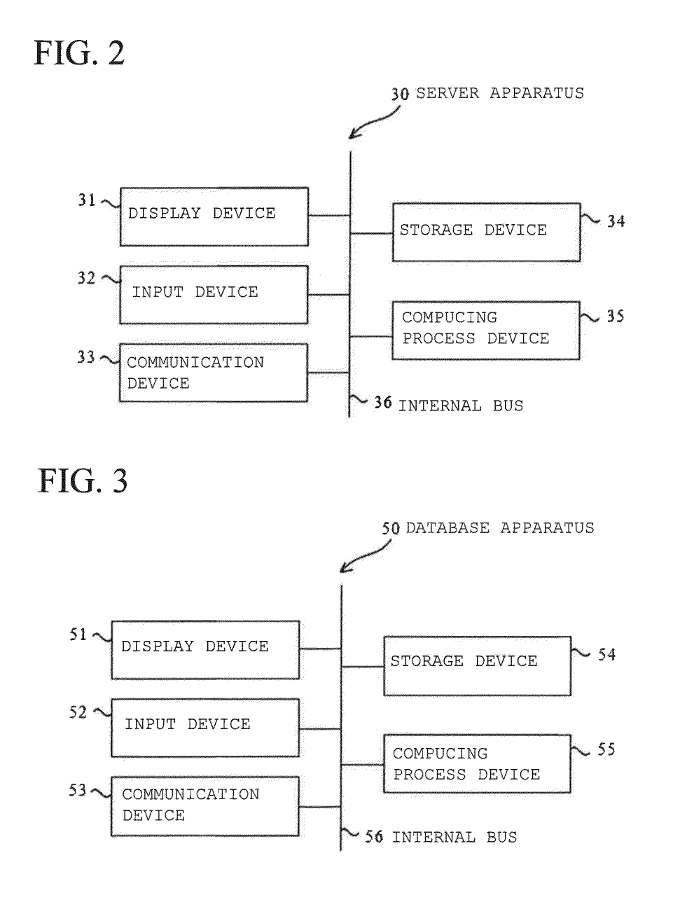

The server apparatus 30 is a computer apparatus which operates under control of an administrating company of health care service. The server apparatus 30 provides health care service to users via a health care site. As illustrated in FIG. 2, the server apparatus 30 has a display device 31 (for example, a liquid crystal display device or an organic EL display), an input device 32 (for example, a mouse and a keyboard), a communication device 33 (for example, an NIC (Network Interface Card)), a storage device 34 (for example, a hard disk, a RAM, and a ROM), a computing process device 35 (for example, a CPU), and an internal bus 36 connecting those components.

The database apparatus 50 is a computer apparatus storing various data uploaded from the user terminals 10 into a database DB and providing it to the server apparatus 30. As illustrated in FIG. 3, the database apparatus 50 has a display device 51, an input device 52, a communication device 53, a storage device 54, a computing process device 55, and an internal bus 56 connecting those components.

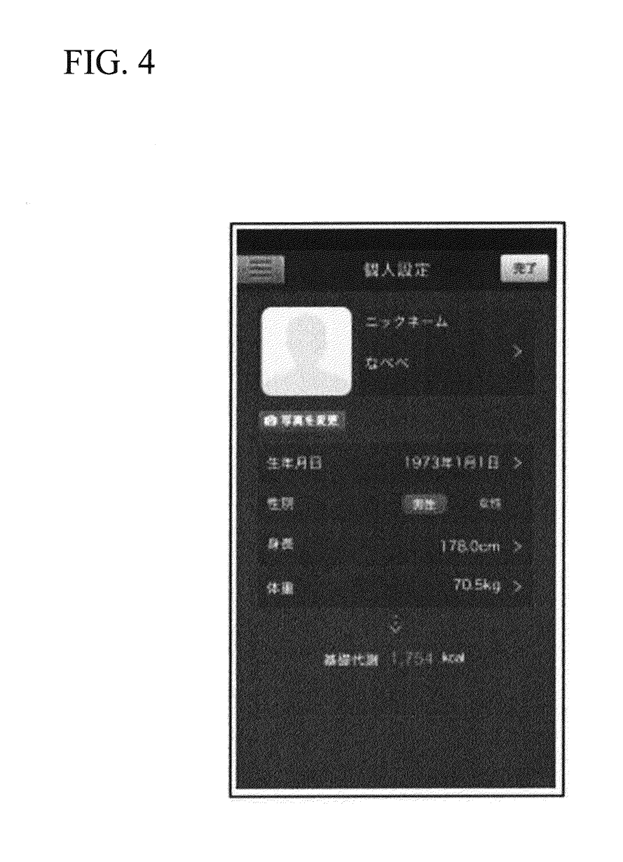

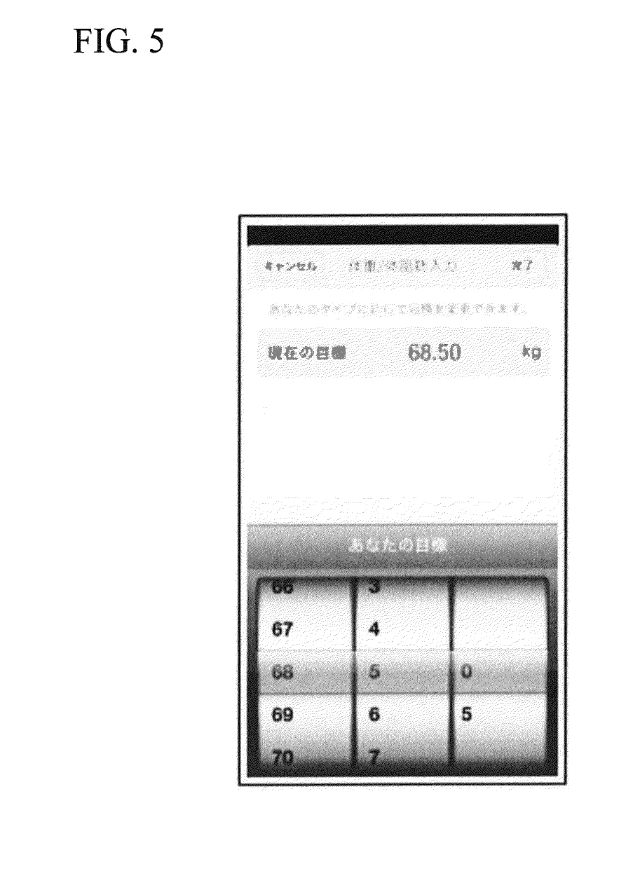

In the embodiment, the user installs a health care site cooperative application AP from an application market, starts it, enters data D_{NN} expressing a nickname of the user, data D_{BIR} expressing birth date, data D_{GDR} expressing sex, data D_{HGH} expressing height, and data D_{TRG} expressing target body weight in an individual setting screen (refer to FIGS. 4 and 5) displayed immediately after the start, and registers the data D_{NN}, D_{BIR}, D_{GDR}, D_{HGH}, and D_{TRG} as individual setting information in the database DB of the database apparatus 50. After registration of the individual setting information, the user receives provision of the health care service via the health care site cooperative application AP at a rate of a few times per day.

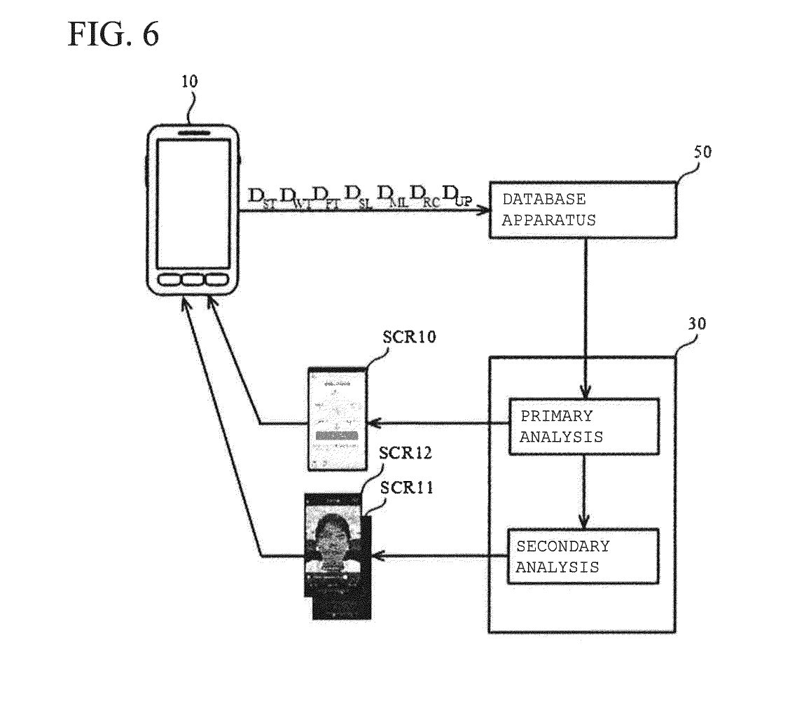

FIG. 6 is a diagram illustrating outline of health care service of the embodiment. As illustrated in FIG. 6, in health care service of the embodiment, the user terminal 10 accesses the database apparatus 50, reads record data D_{ST}, D_{WT}, D_{FT}, DS_{SL} D_{ML}, D_{RC}, and D_{UP} of the following six kinds of record items from the memory of the user terminal 10, and uploads it to the database apparatus 50.

a1. Number-of-steps record data D_{ST}

This is data indicative of a measurement value of the number of steps of the user. In the case where a link according to a radio communication standard (for example, Bluetooth) is established with a number-of-steps measuring device 11 (FIG. 1) worn by the user, the user terminal 10 receives the number of steps measured everyday by the number-of-steps measuring device 11, and records a pair of the received number of steps and date of reception as the number-of-steps record data D_{ST} into the memory.

b1. Body Weight Record Data D_{WT}

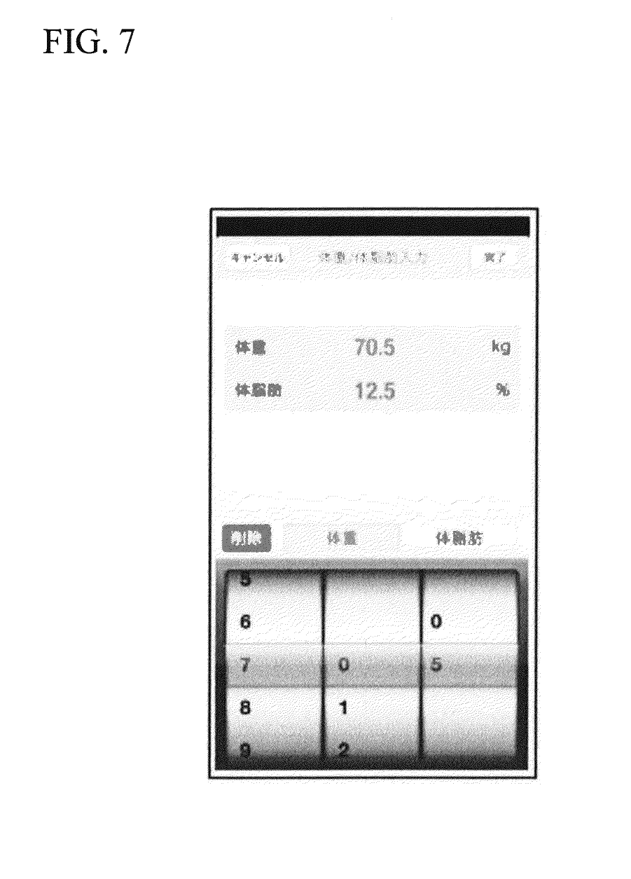

This is data indicative of a measurement value of the body weight of the user. In the case where the body weight of the user is entered via the body weight/body fat percentage input screen (refer to FIG. 7) of the application AP, the user terminal 10 stores a pair of the entered body weight and date of input date as the body weight record data D_{WT} into the memory. In the case where a link according to a radio communication standard (for example, Bluetooth) is established with a body weight measuring device 12 (FIG. 1) owned by the user, the user terminal 10 receives the body weight of the user from the body weight measuring device 12 and records a pair of the received body weight and date of reception date as the body weight record data D_{WT} into the memory.

c1. Body-Fat Record Data Dr

This is data indicative of a measurement value of the body fat percentage of the user. In the case where the body fat percentage of the user is entered via the body weight/body fat percentage input screen (refer to FIG. 7) of the application AP, the user terminal 10 stores a pair of the entered body fat percentage and date of input date as the body fat percentage record data D_{FT} into the memory. In the case where a link according to a radio communication standard (for example, Bluetooth) is established with a body fat percentage measuring device 13 (FIG. 1) owned by the user, the user terminal 10 receives the body fat percentage of the user from the body fat percentage measuring device 13 and records a pair of the received body fat percentage and date of reception date as the body fat percentage record data D_{FT} into the memory.

d1. Sleep Record Data D_{SL}

This is data indicative of bedtime time and wake-up time of the user. In the case where a link according to a radio communication standard (for example, Bluetooth) is established with a sleep time measuring device 14 (FIG. 1) worn by the user, the user terminal 10 receives bedtime and wake-up time of the user from the sleep time measuring device 14 and stores a pair of the bedtime and the wake-up time and date of reception date as sleep record data D_{SL} into the memory.

e1. Meal Record Data D_{ML}

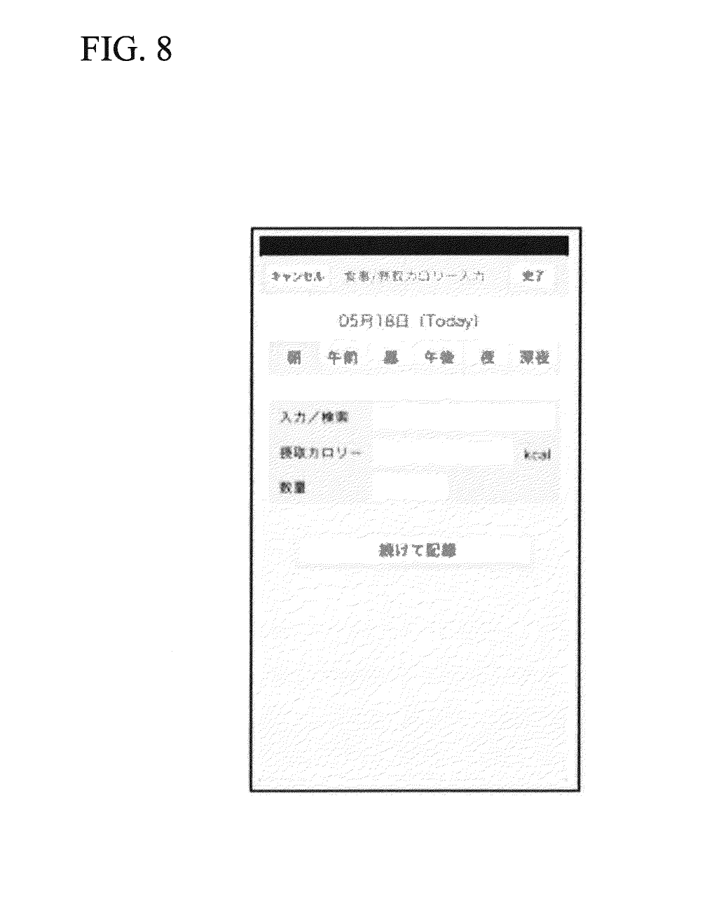

This is data indicative of a record of a meal in the application AP. In the case where the kind of a meal (such as ramen or a beef-on-rice bowl) taken by the user is entered via a meal/taken calorie input screen (refer to FIG. 8) of the application AP, the user terminal 10 stores a pair of the input kind of the meal and input time and date as meal record data D_{ML} into the memory.

f1. Application Start-Up History Record Data D_{RC}

This is data indicative of a record of start-up of the application AP. In the case where the application AP is started, the user terminal 10 stores time and date of start-up as application start-up history record data D_{RC} into the memory.

g1. Upload History Record Data D_{UP}

This is data indicative of a history of uploading of the record data D_{ST}, D_{WT}, D_{FT}, D_{SL}, D_{ML}, D_{RC}, and D_{UP} to the database apparatus 50. Each time the unsent record data D_{ST}, D_{WT}, D_{FT}, D_{SL}, D_{ML}, D_{RC}, and D_{UP} in the memory is uploaded to the database apparatus 50, the user terminal 10 stores time and date of the uploading as upload history record data D_{UP} into the memory.

In FIG. 6, the server apparatus 30 performs a primary analysis of evaluating present health conditions of the user in five kinds of evaluation items of physical strength, anti-aging power, beauty power, awareness level, and continuity on the basis of the record data D_{ST}, D_{WT}, D_{FT}, D_{SL}, D_{ML}, D_{RC}, and D_{UP} of the user stored in the database DB of the database apparatus 50, and presents the result of the primary analysis as a body balance screen SCR10 to the user. The server apparatus 30 performs a secondary analysis of predicting future health conditions of the user from the result of the primary analysis and presents the result of the secondary analysis as future prediction screens SCR11 and SCR12 to the user. The configuration of the screens SCR10, SCR11, and SCR12 will be described later.

Next, the operation of the embodiment will be described. The operation of the embodiment includes a data storing process, a radar chart presenting process, a future face picture presenting process, and a future body weight presenting process. Those processes are executed when the user performs a predetermined operation in a state where a top screen SCR5 of the application AP is displayed in the user terminal 10.

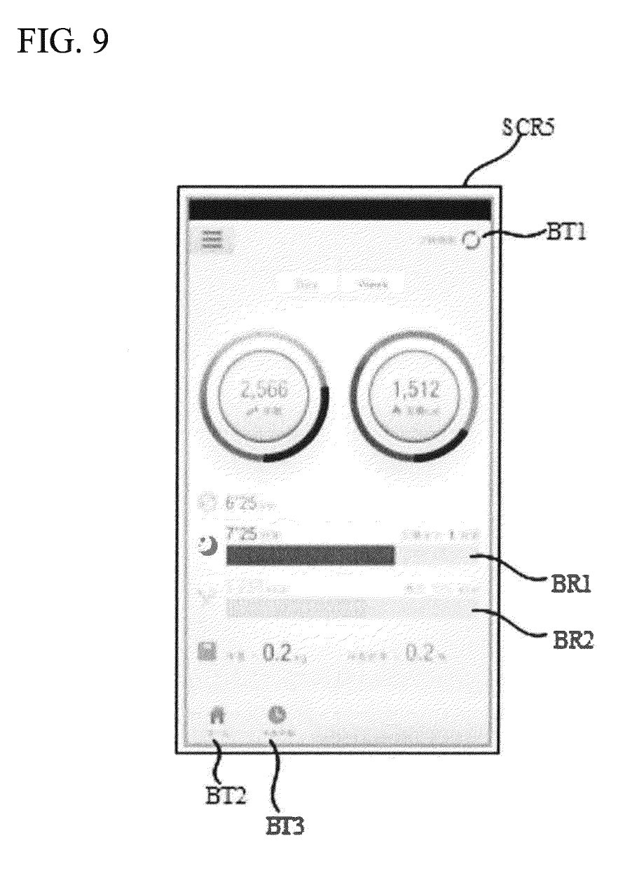

FIG. 9 is a diagram illustrating the top screen SCR5. On the right side of the upper stage in the top screen SCR5, a button BT1 is displayed. Below the button BT1, the latest data D_{ST} (the number of steps, 2566 steps in the example of FIG. 9) in the memory of the user terminal 10 and consumption calorie (1,512 calories in the example of FIG. 9) obtained by inputting the value in a predetermined basal metabolism function are displayed. Below them, a walking distance (6.25 km in the example of FIG. 9) obtained by entering the latest data D_{ST} (the number of steps) in a predetermined distance function is displayed.

Below the walking distance, sleep time obtained by the latest data Dm, (sleep) in the memory of the user terminal 10 (time since bedtime until wake-up time, 7.25 hours in the example of FIG. 9) and a bar BR1 indicative of the length of the sleep time are displayed. Below it, the intake calories (1,253 kilocalories in the example of FIG. 9) obtained according to the kind of a meal indicated by the latest data D_{ML} (meal) in the memory of the user terminal 10 (the kind of the meal entered via the meal/taken calorie input screen of FIG. 8) and a bar BR2 indicative of the amount of the taken calories are displayed. On the left side below the bar BR2, the difference (−0.2 kg in the example of FIG. 9) between the latest data D_{WT} (body weight) in the memory of the user terminal 10 and the data D_{WT}(body weight) recorded before the latest one is displayed. On the right side, the difference (+0.2% in the example of FIG. 9) between the latest data D_{FT} (body fat percentage) in the memory of the user terminal 10 and the data D_{FT} recorded before the latest one is displayed.

At the bottom of the screen SCR5, the two buttons BT2 and BT3 are arranged side by side. In the button BT2, a picture simulating a house and characters of “home” are displayed. In the button BT3, a picture simulating a clock and characters of “future prediction” are displayed. In the screen SRC5, the user performs an operation of choosing desired one of the button BT2 of “home” and the button BT3 of “future prediction” by touching it with his/her finger. In the case where the button BT2 of “home” is selected, the user terminal 10 re-displays the screen SCR5.

In the case where the button BT1 in the screen SRC5 is selected, the user terminal 10 accesses the database apparatus 50, reads the data D_{ST}, D_{WT}, D_{FT}, D_{SL}, D_{ML}, D_{RC}, and D_{UP} stored in the memory in the terminal 10 during a period since the access of last time to the access of this time from the memory, and transmits the read record data D_{ST}, D_{WT}, D_{FT}, D_{SL}, D_{ML}, D_{RC}, and D_{UP} to the database apparatus 50. During running of the application AP, every lapse of predetermined time, the user terminal 10 accesses the database apparatus 50 and performs a similar transmitting process. In the case where the data D_{ST}, D_{WT}, D_{FT}, D_{SL}, D_{ML}, D_{RC}, and D_{UP} is transmitted from the user terminal 10, the database apparatus 50 performs a data storing process. In the data storing process, the database apparatus 50 stores the data D_{ST}, D_{WT}, D_{FT}, D_{SL}, D_{ML}, D_{RC}, and D_{UP} received from the user terminal 10 in the database DB so as to be associated with identification information peculiar to the user as the transmitter.

In the case where the button BT3 in the screen SRC5 is selected, the user terminal 10 transmits a message requesting provision of a radar chart (HTTP (Hyper Text Transfer Protocol) request) to the server apparatus 30. On receipt of the message, the server apparatus 30 performs a radar chart presenting process. The radar chart presenting process is a process of extracting the record data D_{ST}, D_{WT}, D_{FT}, D_{SL}, D_{ML}, D_{RC}, and D_{UP} recorded during a most-recent first period T1 (for example, period T1=7 days) from the record data D_{ST}, D_{WT}, D_{FT}, D_{SL}, D_{ML}, D_{RC}, and D_{UP} of the user in the database apparatus 50, obtaining moving average deviations MA_{ST}, MA_{WT}, MA_{SL}, MA_{ML}, MA_{RC}, and MA_{UP} by the kinds of the extracted record data D_{ST}, D_{WT}, D_{FT}, D_{SL}, D_{ML}, D_{RC}, and D_{UP}, by analyzing the obtained moving average deviations MA_{ST}, MA_{WT}, MA_{BL}, MA_{ML}, MA_{RC}, and MA_{UP} in accordance with a predetermined algorithm, obtaining balance parameters PR indicating the health conditions of the user as an evaluation level Lv of five kinds of evaluation items of physical strength, anti-aging power, beauty power, awareness level, and continuity, and displaying a screen including the obtained balance parameters PR as a radar chart as the body balance screen SCR10 in the user terminal 10.

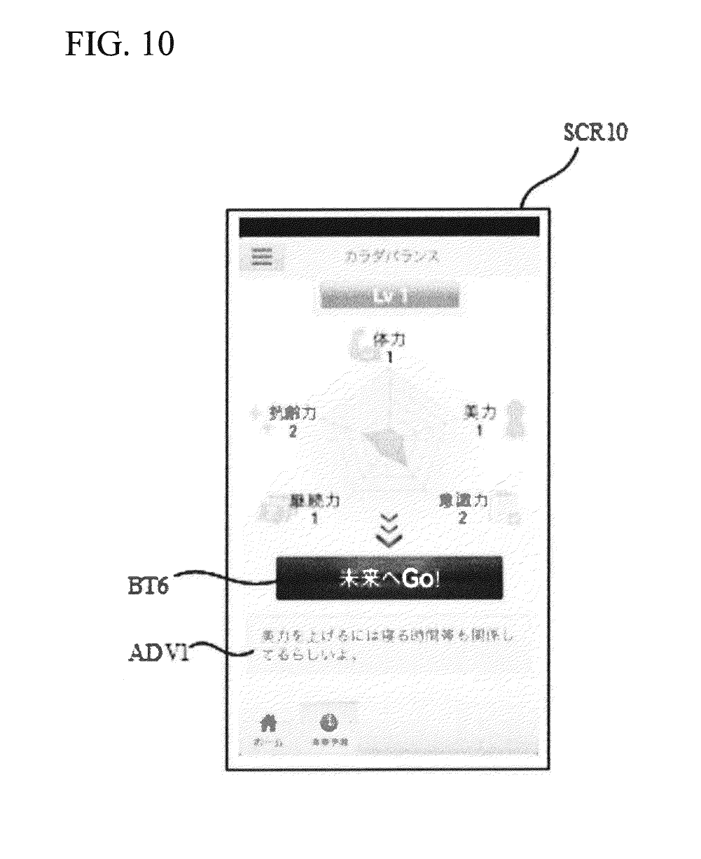

FIG. 10 is a diagram illustrating the body balance screen SCR10. As illustrated in FIG. 10, a radar chart having a regular pentagon shape is displayed in the center of the screen SCR 10. The radar chart in the screen SCR 10 is obtained by plotting the evaluation levels Lv of the evaluation items of physical strength, anti-aging power, beauty power, continuity, and awareness level in five-level evaluation of 1 to 5 onto five evaluation level axes extending from the center to vertexes of the regular pentagon shape (in the example of FIG. 10, physical strength is 1, anti-aging power is 2, beauty power is 1, continuity is 1, and awareness level is 2). Above the radar chart in the screen SCR10, an average evaluation level Lv_{AVE} obtained by averaging the evaluation levels Lv of the five evaluation items (in the example of FIG. 10, Lv_{AVE}=Lv1) is displayed. Below the radar chart in the screen SCR10, a button BT6 is displayed. In the button BT6, characters “Go to the future” are written. Below the button BT6 in the screen SCR10, advice ADV1 according to the evaluation level Lv (in the example, “beauty power is related to sleep time zone”) is displayed.

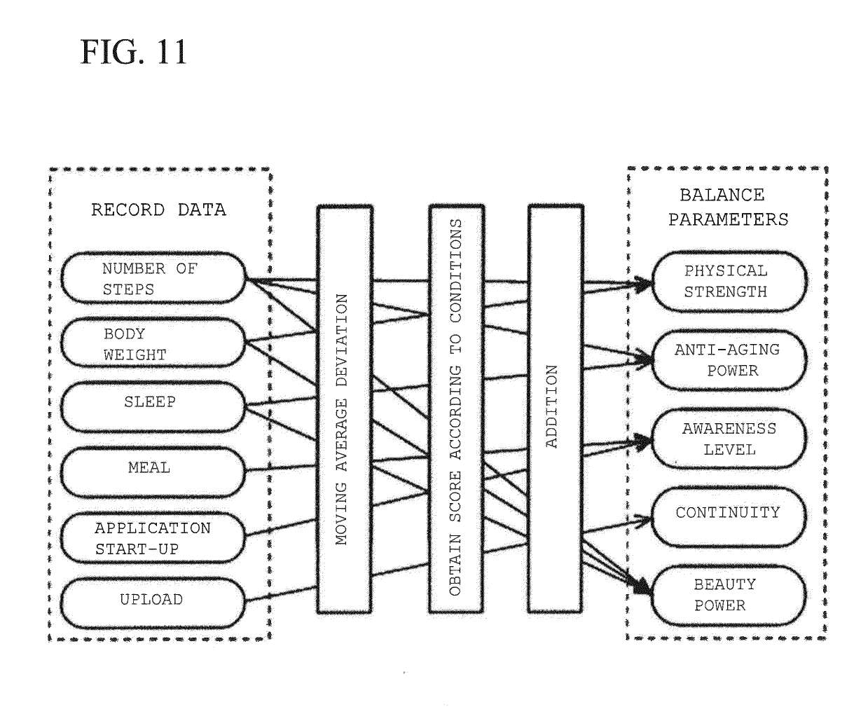

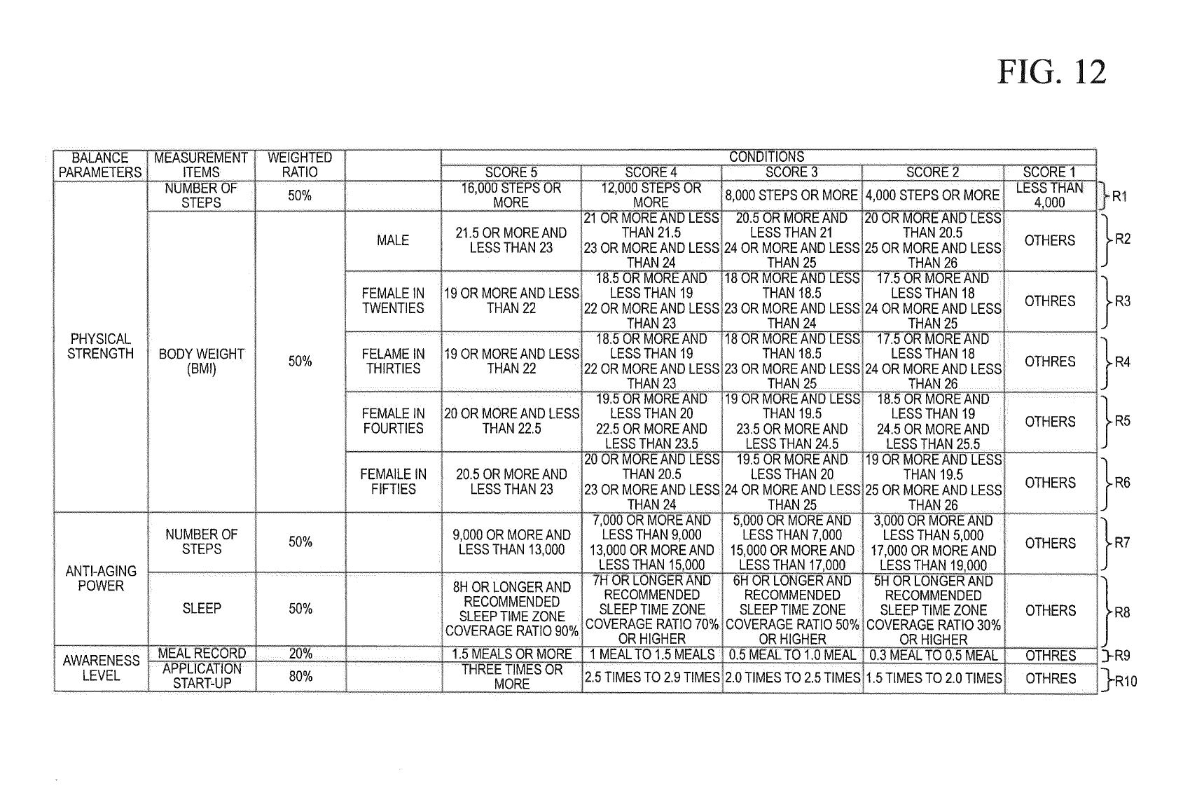

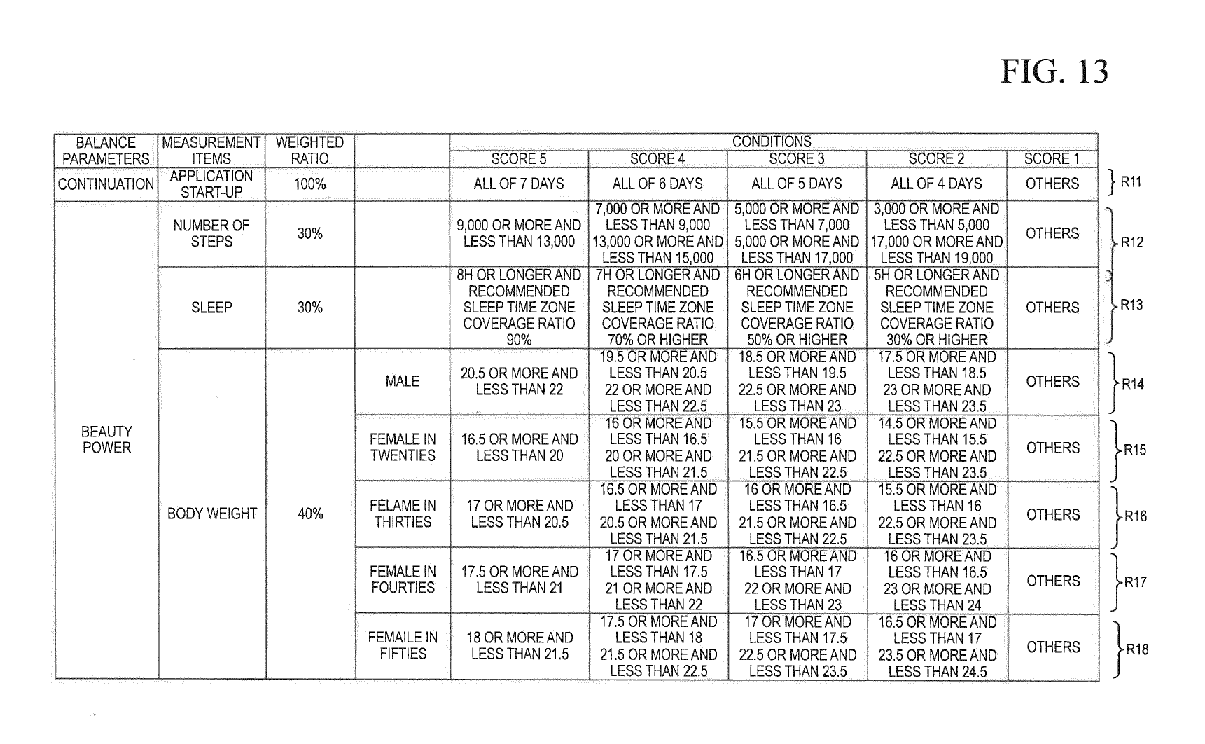

FIG. 11 is a diagram conceptually illustrating content of processing in a radar chart presentation process. As illustrated in FIG. 11, in the radar chart presenting process, the computing process device 35 of the server apparatus 30 obtains scores by the evaluation items by collating the respective moving average deviations MA_{ST}, MA_{WT}, MA_{SL}, MA_{ML}, MA_{RC}, and MA_{UP} in the latest period T1 (T1=7 days) of the record data D_{ST} (the number of steps), record data D_{WT}(body weight), record data D_{SL} (sleep), record data D_{ML} (meal), record data D_{RC} (application start-up history), and record data D_{UP} (upload history) with conditions in the storage device 34 and conditions by the evaluation items shown in a load ratio table TBL1 (FIGS. 12 and 13), and sets a value obtained by adding the obtained score at a weighted ratio by the evaluation items shown in the table TBL1 as the evaluation level Lv of each of the evaluation items.

The procedure (algorithm) of the process of calculating the evaluation level Lv of each of the evaluation items with the table TBL1 is as follows.

a2. Process of Calculating Evaluation Level Lv of Physical Strength

In the calculating process, the computing process device 35 sets a record R1 in the table TBL1 as a record to be referred to, refers to conditions associated with scores 1, 2, 3, 4, and 5 in the record R1 to be referred to, determines whether the moving average deviation MA_{ST} of the record data D_{ST} (the number of steps) satisfies any of the conditions or not, and selects the score associated with the determined condition. The computing process device 35 converts the moving average deviation MA_{WT} of the record data D_{WT}(body weight) to a BMI (Body Math Index) value. The BMI value is a value obtained by dividing the square of the moving average deviation MA_{WT} of the record data D_{WT} (body weight) by the data D_{HGH} (height) of the user. After that, the computing process device 35 sets a combination of gender indicated by the data D_{GDR} (gender) of the user in the records R2 to R6 in the table TBL1 and age determined by the data D_{BIR} (birth date) as a record to be referred to, refers to conditions associated with scores 1, 2, 3, 4, and 5 in the record R2 (or R3, R4, R5, or R6) to be referred to, determines whether the BMI value satisfies any of the conditions or not, and selects the score associated with the determined condition. The computing process device 35 adds the score selected from the record R1 in the table TBL1 and the score selected from the record R2 (or R3, R4, R5, or R6) at a ratio of 50%:50%, and sets the addition result as the evaluation level Lv of physical strength.

b2. Process of Calculating Evaluation Level Lv of Anti-Aging Power

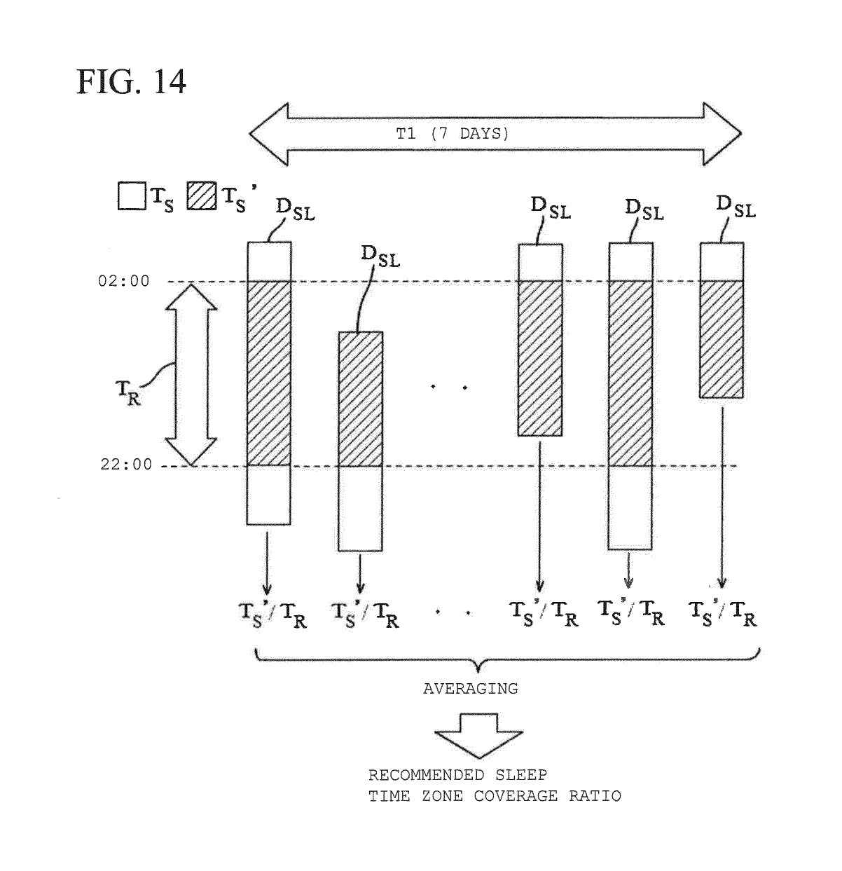

In the calculating process, the computing process device 35 sets a record R7 in the table TBL1 as a record to be referred to, refers to conditions associated with scores 1, 2, 3, 4, and 5 in the record R7 to be referred to, determines whether the moving average deviation MA_{ST} of the record data D_{ST} (the number of steps) satisfies any of the conditions or not, and selects the score associated with the determined condition. The computing process device 35 obtains a recommended sleep time zone cover ratio R_{C}. The recommended sleep time zone cover ratio R_{C} is a value expressing the degree that a sleep time T_{S} (time from the bedtime to wake-up time indicated by the data D_{SL}) of the user overlaps a time zone T_{R} from 22:00 to 02:00 in which the secretion amount of growth hormone is maximized. In the process of the calculating the recommended sleep time zone cover ratio R_{C}, as illustrated in FIG. 14, an operation of dividing time T_{S}′ overlapping the time zone T_{R} in the sleep time T_{S} (time from the bedtime to wake-up time) indicated by the data D_{SL} by four hours as the length of the recommended time zone T_{R} is performed with respect to data D_{SL} (sleep) for each of the record days extracted from the database DB. The division results T_{S}′/T_{R} by record days are averaged, and an average value is used as the recommended sleep time zone cover ratio R_{C}. The computing process device 35 sets a record R8 in the table TBL1 as a record to be referred to, refers to conditions associated with scores 1, 2, 3, 4, and 5 in the record R8 to be referred to, determines whether the moving average deviation MA_{SL} of the sleep time indicated by the record data D_{SL} (sleep) and the recommended sleep time zone cover ratio R_{C} satisfy any of the conditions or not, and selects the score associated with the determined condition. The computing process device 35 adds the score selected from the record R7 in the table TBL1 and the score selected from the record R8 at a ratio of 50%:50%, and sets the addition result as the evaluation level Lv of anti-aging power.

c2. Process of Calculating Evaluation Level Lv of Awareness Level

In the calculating process, the computing process device 35 sets a record R9 in the table TBL1 as a record to be referred to, refers to conditions associated with scores 1, 2, 3, 4, and 5 in the record R9 to be referred to, determines whether the moving average deviation MA_{ML} of the record data D_{ML} (meal) satisfies any of the conditions or not, and selects the score associated with the determined condition. The computing process device 35 sets a record R10 in the table TBL1 as a record to be referred to, refers to conditions associated with scores 1, 2, 3, 4, and 5 in the record R10 to be referred to, determines whether the moving average deviation MA_{RC} of the record data D_{RC} (application start history) satisfies any of the conditions or not, and selects the score associated with the determined condition. The computing process device 35 adds the score selected from the record R9 in the table TBL1 and the score selected from the record R10 at a ratio of 20%:80%, and sets the addition result as the evaluation level Lv of awareness level.

d2. Process of Calculating Evaluation Level Lv of Continuity

In the calculating process, the computing process device 35 sets a record R11 in the table TBL1 as a record to be referred to, refers to conditions associated with scores 1, 2, 3, 4, and 5 in the record R11 to be referred to, determines whether the moving average deviation MA_{UP} Of the record data D_{UP} (data upload history) satisfies any of the conditions or not, and selects the score associated with the determined condition. The computing process device 35 sets the score selected from the record R11 in the table TBL1 as the evaluation level Lv of continuity.

e2. Process of Calculating Evaluation Level Lv of Beauty Power

In the calculating process, the computing process device 35 sets a record R12 in the table TBL1 as a record to be referred to, refers to conditions associated with scores 1, 2, 3, 4, and 5 in the record R12 to be referred to, determines whether the moving average deviation MA_{ST} of the record data D_{ST} (number of steps) satisfies any of the conditions or not, and selects the score associated with the determined condition. The computing process device 35 sets a record R13 in the table TBL1 as a record to be referred to, refers to conditions associated with scores 1, 2, 3, 4, and 5 in the record R13 to be referred to, determines whether the moving average deviation MA_{SL} of the sleep time indicated by the record data D_{SL} (sleep) and the recommended sleep time zone cover ratio R_{C} obtained by the moving average deviation MA_{SL} satisfy any of the conditions or not, and selects the score associated with the determined condition. The computing process device 35 sets a combination of gender indicated by the data D_{GDR} (gender) of the user in the records R14 to R18 in the table TBL1 and age determined by the data D_{BIR} (birth date) as a record to be referred to, refers to conditions associated with scores 1, 2, 3, 4, and 5 in the record R14 (or R15, R16, R17, or R18) to be referred to, determines whether the BMI value obtained from the moving average deviation MA_{WT} of the record data D_{WT}(body weight) satisfies any of the conditions or not, and selects the score associated with the determined condition. The computing process device 35 adds the score selected from the record R12 in the table TBL1, the score selected from the record R13, and the score selected from the record R14 (or R15, R16, R17, or R18) at a ratio of 30%:30%:40%, and sets the addition result as the evaluation level Lv of beauty power.

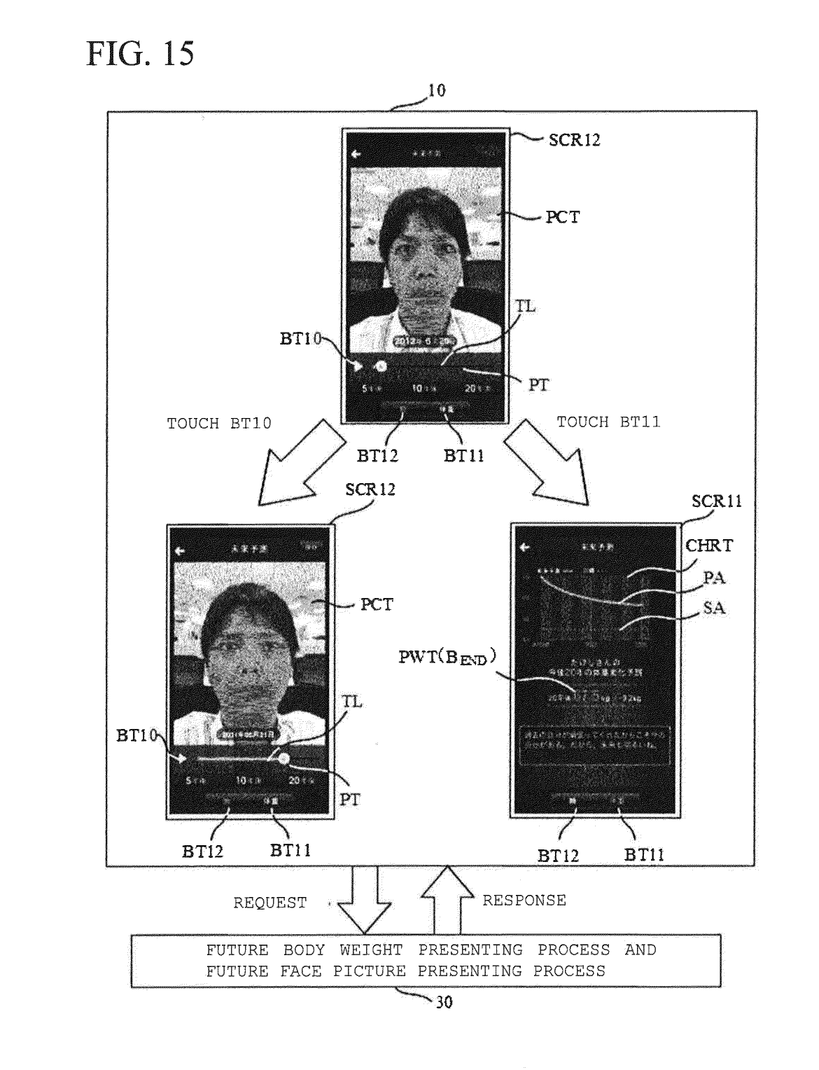

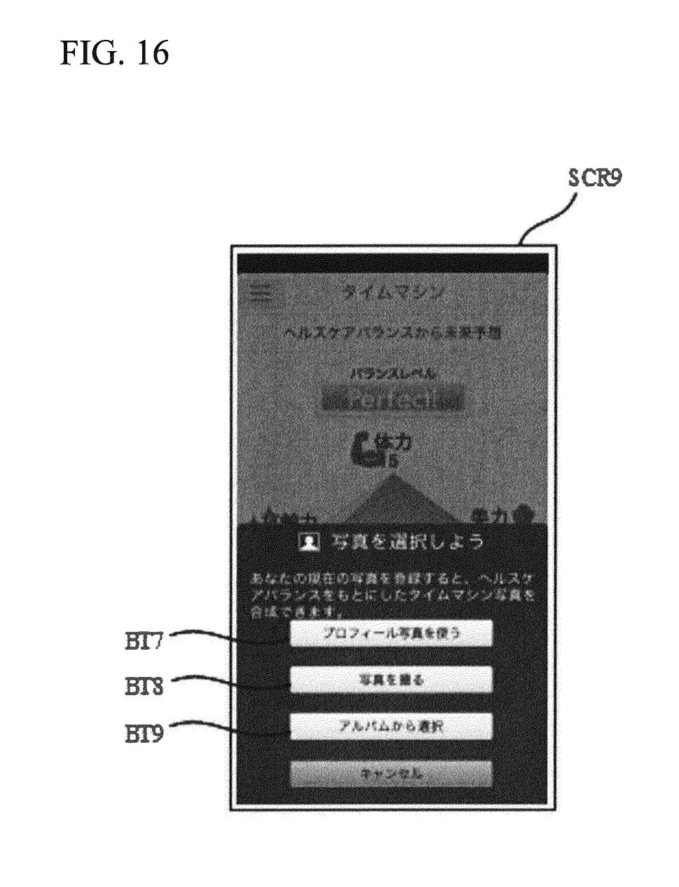

FIG. 15 is a diagram conceptually illustrating a future weight presenting process and a future face presenting process. In the embodiment, in the case where an operation of touching the button BT3 of “future prediction” in the top screen SCR5 (FIG. 9) is performed, the user terminal 10 displays a picture selection screen SCR9 illustrated in FIG. 16 to the display. In the screen SCR9, a button BT7 in which “use profile picture” is written, a button BT8 in which “take picture” is written, and a button BT9 in which “select from album” is written are displayed. When the user selects any of the buttons BT7, BT8, and BT9 in the screen SCR9 and takes or selects a picture of the user, a message (HTTP request) requesting provision of future prediction is transmitted to the server apparatus 30. On receipt of the message, the server apparatus 30 performs a future body weight presenting process and a future face picture presenting process, sends a message (HTTP response) including results of the processes back to the user terminal 10, and displays future prediction screens SCR11 and SCR12 on the terminal 10.

The future body weight presenting process is a process of extracting the record data D_{WT} recorded in a most-recent second period T2 (T2>T1, for example, T2=90 days) in the series of record data D_{WT}(body weight) of the user in the database apparatus 50, obtaining a linear approximation line A of transition of the extracted record data D_{WT} in the time T2, obtaining a first weight prediction line A′ obtained by correcting the linear approximation line A with a physical strength coefficient K_{WT} of the magnitude according to the value of the balance parameter PR of the physical strength, obtaining a second body weight prediction line A″ by correcting the first body weight prediction line A′ with a basal metabolism coefficient K_{MTB} of the magnitude according to the combination of the gender (data D_{GDR}) of the user and the age (age determined by the data D_{BIR} (birth date)), and displaying a screen including a graph CHRT of transition of a future prediction body weight PWT (β) along the tilt α″ of the second body weight prediction line A″ as a first future prediction screen SCR11 on the user terminal 10 of the user.

The future face picture presenting process is a process of converting the evaluation levels Lv of the five kinds of the evaluation items of physical strength, anti-aging power, beauty power, awareness level, and continuity to an aging level Lv_{AGING}, indicative of the degree of progression of aging of the user and displaying, as a second future prediction screen SCR12, a screen including the future prediction face picture obtained by performing an image process so that the converted aging level Lv_{AGING} appears as wrinkles and spots of the face and the tilt α″ of the body weight prediction line A″ appears as extension and contraction in the lateral direction of the face on a face picture of the user on the user terminal 10 of the user.

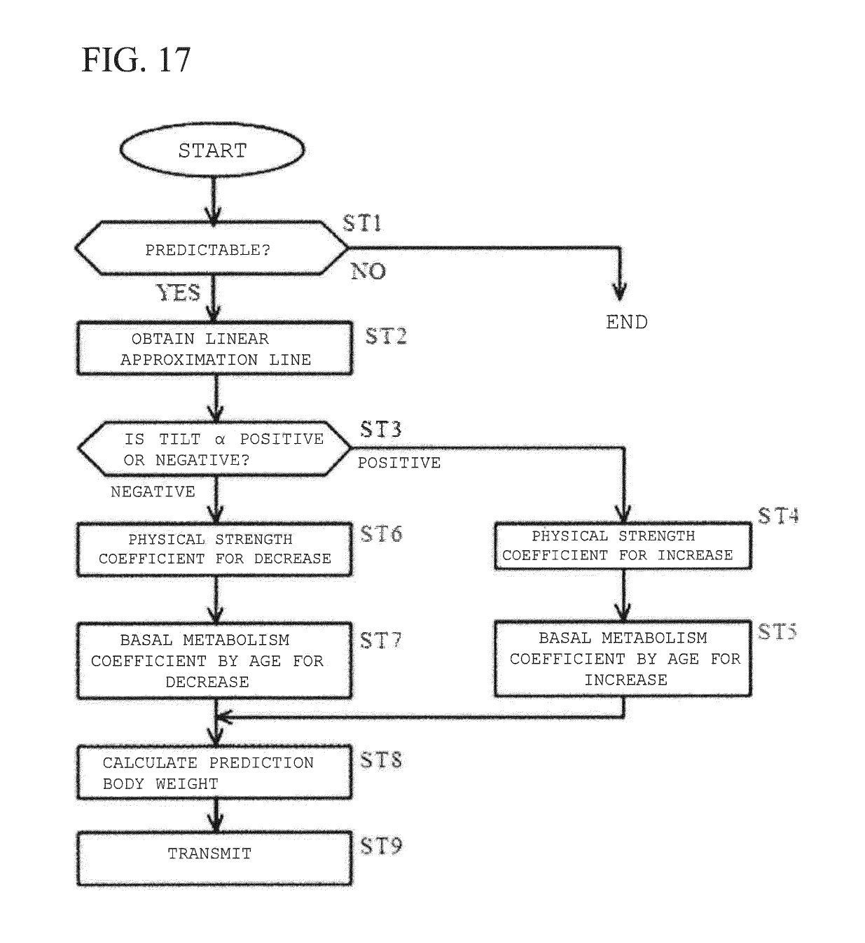

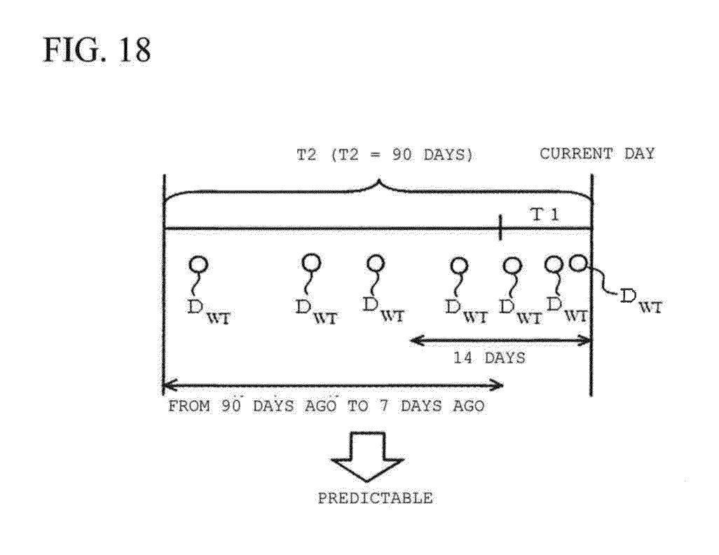

More specifically, as illustrated in the flowchart of FIG. 17, in the future body weight presenting process, the computing process device 35 determines whether the future body weight of the user can be predicted or not (ST1). In step ST1, in the case where there is a recording data D_{WT}(body weight) group of the user satisfying the following two conditions a3 and b3 within the database apparatus 50, it is determined that the future body weight of the user can be predicted. FIG. 18 is a diagram illustrating an example of a record distribution of the data D_{ST} (body weight) satisfying the conditions a3 and b3.

a3. There are three or more pieces of the record data D_{ST} recorded in the past 14 days
b3. There is One or More Pieces of the Record Data D_{WT} Recorded within a Period Since 90 Days Ago Until 7 Days Ago.

In the case where the future body weight of the user can be predicted (Yes in ST1), the computing process device 35 calculates an average value of every five days of the record data D_{WT} recorded during the most-recent period T2 (T2=90 days), an average value MA_{WT}(0-5) of the record data D_{WT} of zero to five days ago, an average value MA_{WT}(6-10) of the record data D_{WT} of six to 10 days ago, . . . and an average value MA_{WT}(86-90) of the record data D_{WT} of 86 to 90 days ago, and obtains a linear approximation line A of a graph in which the average values MA_{WT}(0-5), MA_{WT}(6-10), . . . MA_{WT}(86-90) are arranged on the time axis (ST2).

The computing process device 35 determines whether the sign of the tilt α of the linear approximation line A obtained in step ST2 is positive or negative (ST3). When the body weight of the user is in an increasing trend, the determination result of step ST3 is “positive”. When the body weight of the user is in a decreasing trend, the determination result of step ST3 is “negative”.

In the case where the sign of the tilt α of the linear approximation line A is positive, the computing process device 35 obtains a body weight prediction line A′ derived by correcting the linear approximation line A with a physical strength coefficient K_{WT} for increase (ST4). In step ST4, the computing process device 35 selects a physical strength coefficient K_{WT} for increase corresponding to the evaluation level Lv of physical strength of the user from physical strength coefficients K_{WT} for increase stored as a physical strength coefficient table TBL2-1 for increase in the storage device 34.

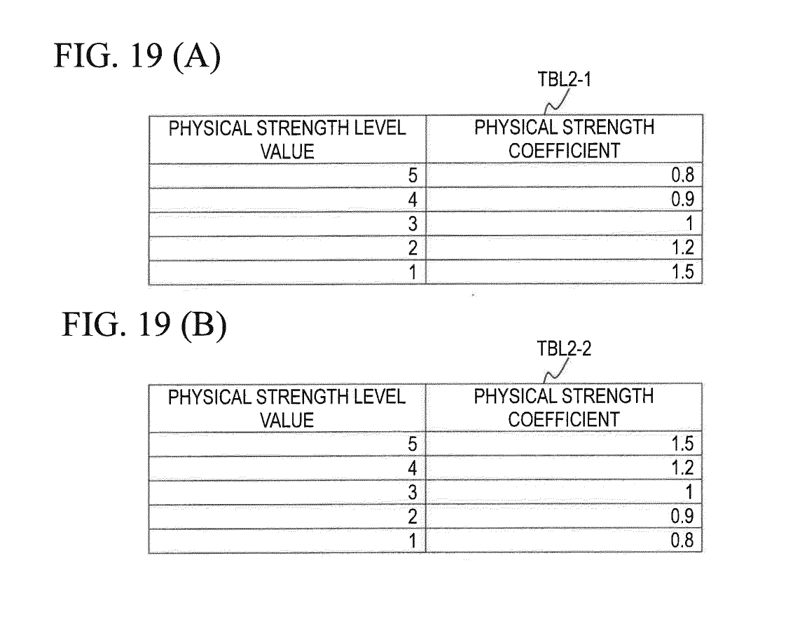

FIG. 19(A) is a diagram indicating data in the table TBL2-1. In the table TBL2-1, the physical strength coefficient K_{WT}(5) for increase in the case where the evaluation level Lv of physical strength is five is 0.8, the physical strength coefficient K_{WT}(4) for increase in the case where the evaluation level Lv of physical strength is four is 0.9, the physical strength coefficient K_{WT}(3) for increase in the case where the evaluation level Lv of physical strength is three is 1, the physical strength coefficient K_{WT}(2) for increase in the case where the evaluation level Lv of physical strength is two is 1.2, and the physical strength coefficient K_{WT}(1) for increase in the case where the evaluation level Lv of physical strength is one is 1.5.

The computing process device 35 multiplies the tilt α of the linear approximation line A with the physical strength coefficient K_{WT} for increase selected from the table TBL2-1 and sets a linear line having a tile of α′ (α′=α·K_{WT}) as a body weight prediction line A′.

Next, the computing process device 35 obtains a body weight prediction line A″ obtained by correcting the body weight prediction line A′ obtained in step ST4 with the basal metabolism coefficient K_{MTB} for increase (ST5). In step ST5, the basal metabolism coefficient K_{MTB} for increase corresponding to the data D_{GDR} (gender) of the user is selected from the basal metabolism coefficients for increase K_{MTB}(20-24), K_{MTB}(25-29), K_{MTB}(30-34), K_{MTB}(35-39), K_{MTB}(40-44), K_{MTB}(45-49), and K_{MTB}(50-) of ages by five years by gender, which are stored as a basal metabolism coefficient table TBL3-1 for increase in the storage device 34.

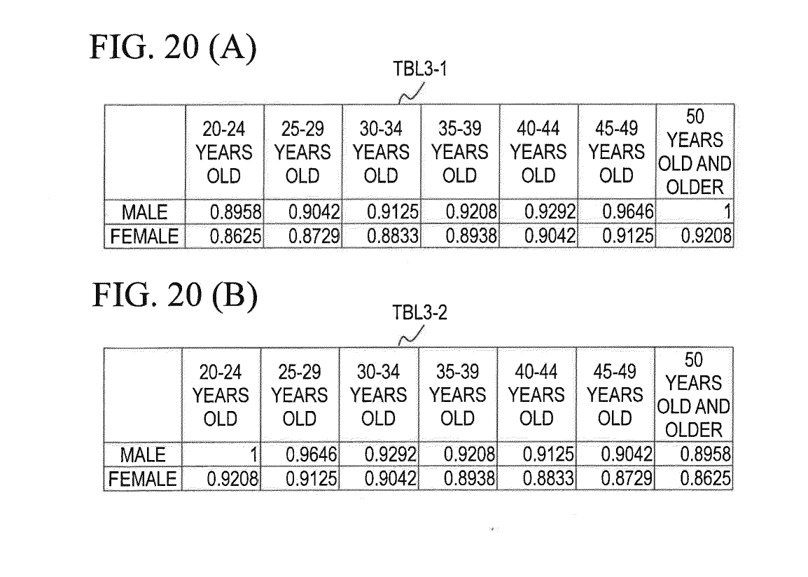

FIG. 20(A) is a diagram indicating data in the table TBL3-1. In the table TBL3-1, with respect to males, the basal metabolism coefficient K_{MTB}(20-24) for increase at age of 20 to 24 is 0.8958, the basal metabolism coefficient K_{MTB}(25-29) for increase at age of 25 to 29 is 0.9042, the basal metabolism coefficient K_{MTB}(30-34) for increase at age of 30 to 34 is 0.9125, the basal metabolism coefficient K_{MTB}(35-39) for increase at age of 35 to 39 is 0.9208, the basal metabolism coefficient K_{MTB}(40-44) for increase at age of 40 to 44 is 0.9292, the basal metabolism coefficient K_{MTB}(45-49) for increase at age of 45 to 49 is 0.9646, and the basal metabolism coefficient K_{MTB}(50-) for increase at age of 50 and older is 1.

With respect to females, the basal metabolism coefficient K_{MTB}(20-24) for increase at age of 20 to 24 is 0.8625, the basal metabolism coefficient K_{MTB}(25-29) for increase at age of 25 to 29 is 0.8729, the basal metabolism coefficient K_{MTB}(30-34) for increase at age of 30 to 34 is 0.8833, the basal metabolism coefficient K_{MTB}(35-39) for increase at age of 35 to 39 is 0.8938, the basal metabolism coefficient K_{MTB}(40-44) for increase at age of 40 to 44 is 0.9042, the basal metabolism coefficient K_{MTB}(45-49) for increase at age of 45 to 49 is 0.9125, and the basal metabolism coefficient K_{MTB}(50-) for increase at age of 50 and older is 0.9208.

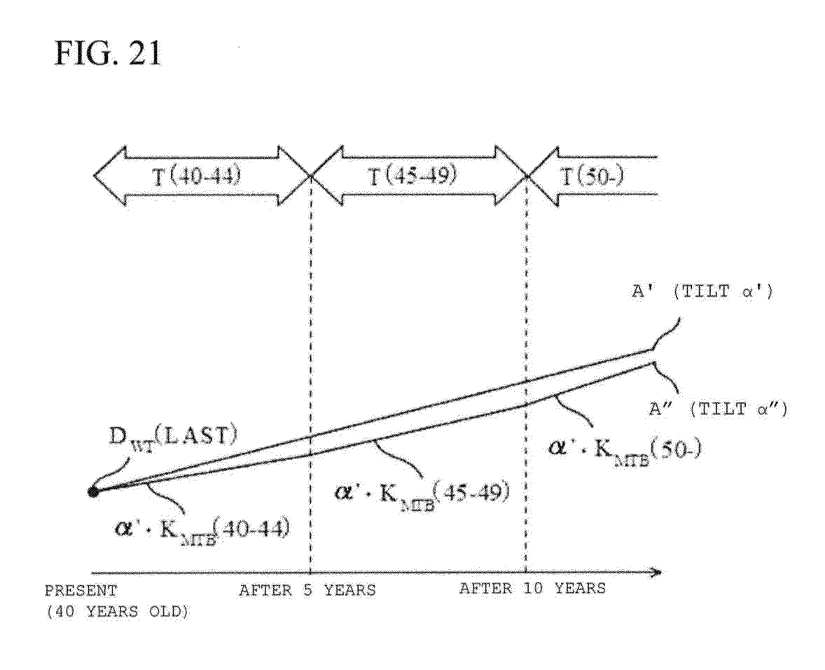

As illustrated in FIG. 21, the computing process device 35 sets data of the latest record date in the past six month extracted from the database DB as latest record data D_{WT}(LAST), obtains an interval of each of ages in future in the case of connecting the body weight prediction line A″ to the record data D_{WT}(LAST) (in the example of FIG. 21, interval T(40-44) from 40 years old to 44 years old, interval T(45-49) from 45 years old to 49 years old, and interval T(50-) of fifty years old and older), and multiplies the tilt α′ in the interval of each of the ages in the body weight prediction line A′ with a corresponding basal metabolism coefficient in the basal metabolism coefficients for increase K_{MTB}(20-24), K_{MTB}(25-29), K_{MTB}(30-34), K_{MTB}(35-39), K_{MTB}(40-44), K_{MTB}(45-49), and K_{MTB}(50-) selected from the table TBL3-1. A line having the individual tilt α″ by age is used as the body weight prediction line A″.

In FIG. 17, in the case where the sign of the tilt α of the linear approximation line A is negative, the computing process device 35 obtains a body weight prediction line A′ derived by correcting the linear approximation line A with a physical strength coefficient Kr for decrease (ST6). In step ST6, the computing process device 35 selects a physical strength coefficient K_{WT} for decrease corresponding to the evaluation level Lv of physical strength of the user from physical strength coefficients K_{WT} for decrease stored as a physical strength coefficient table TBL2-2 for decrease in the storage device 34.

FIG. 19(B) is a diagram indicating data in the table TBL2-2. In the table TBL2-2, the physical strength coefficient K_{WT}(5) for decrease in the case where the evaluation level Lv of physical strength is five is 1.5, the physical strength coefficient K_{WT}(4) for decrease in the case where the evaluation level Lv of physical strength is four is 1.2, the physical strength coefficient K_{WT}(3) for decrease in the case where the evaluation level Lv of physical strength is three is 1, the physical strength coefficient K_{WT}(2) for decrease in the case where the evaluation level Lv of physical strength is two is 0.9, and the physical strength coefficient K_{WT}(1) for decrease in the case where the evaluation level Lv of physical strength is one is 0.8.

The computing process device 35 multiplies the tilt α of the linear approximation line A with the physical strength coefficient K_{WT} for decrease selected from the table TBL2-2 and sets a linear line having a tile of α′ (α′=α·K_{WT}) as a body weight prediction line A′.

Next, the computing process device 35 obtains a body weight prediction line A″ obtained by correcting the body weight prediction line A′ obtained in step ST6 with the basal metabolism coefficient K_{MTB} for decrease (ST7). In step ST7, the basal metabolism coefficient K_{MTB} for decrease corresponding to the data D_{GDR} (gender) of the user is selected from the basal metabolism coefficients for decrease K_{MTB}(20-24), K_{MTB}(25-29), K_{MTB}(30-34), K_{MTB}(35-39), K_{MTB}(40-44), K_{MTB}(45-49), and K_{MTB}(50-) of ages by five years by gender, which are stored as a basal metabolism coefficient table TBL3-2 for decrease in the storage device 34.

FIG. 20(B) is a diagram indicating data in the table TBL3-2. In the table TBL3-2, with respect to males, the basal metabolism coefficient K_{MTB}(20-24) for decrease at age of 20 to 24 is 1, the basal metabolism coefficient K_{MTB}(25-29) for decrease at age of 25 to 29 is 0.9646, the basal metabolism coefficient K_{MTB}(30-34) for decrease at age of 30 to 34 is 0.9292, the basal metabolism coefficient K_{MTB}(35-39) for decrease at age of 35 to 39 is 0.9208, the basal metabolism coefficient K_{MTB}(40-44) for decrease at age of 40 to 44 is 0.9125, the basal metabolism coefficient K_{MTB}(45-49) for decrease at age of 45 to 49 is 0.9042, and the basal metabolism coefficient K_{MTB}(50-) for decrease at age of 50 and older is 0.8958.

With respect to females, the basal metabolism coefficient K_{MTB}(20-24) for decrease at age of 20 to 24 is 0.9208, the basal metabolism coefficient K_{MTB}(25-29) for decrease at age of 25 to 29 is 0.9125, the basal metabolism coefficient K_{MTB}(30-34) for decrease at age of 30 to 34 is 0.9042, the basal metabolism coefficient K_{MTB}(35-39) for decrease at age of 35 to 39 is 0.8938, the basal metabolism coefficient K_{MTB}(40-44) for decrease at age of 40 to 44 is 0.8833, the basal metabolism coefficient K_{MTB}(45-49) for decrease at age of 45 to 49 is 0.8729, and the basal metabolism coefficient K_{MTB}(50-) for decrease at age of 50 and older is 0.8625.

The computing process device 35 obtains an interval of each of ages in future in the case of connecting the body weight prediction line A″ to the latest record data D_{WT}(LAST), and multiplies the tilt α′ in the interval of each of the ages in the body weight prediction line A′ with a corresponding basal metabolism coefficient in the basal metabolism coefficients for decrease K_{WT}(20-24), K_{MTB}(25-29), K_{MTB}(30-34), K_{MTB}(35-39), K_{MTB}(40-44), K_{MTB}(45-49), and K_{MTB}(50-) selected from the table TBL3-2. A line having the individual tilt α″ by age is used as the body weight prediction line A″.

In FIG. 17, after execution of step ST5 or ST7, the computing process device 35 calculates a prediction body weight PWT(β) at each time point in a period from the present time point to the prediction end point after a period T3 (for example, the period T3=20 years) in the case where the body weight of the user shifts along the body weight prediction line A″ (ST8). In step ST8, the computing process device 35 determines the mutual magnitude relations of the latest record data D_{WT}(LAST), average value MA_{WT}(86-90) of the record data D_{WT} of 86 to 90 days ago, target body weight (target body weight determined by the user as data D_{TRG}), and standard body weight (standard body weight which is preliminarily set on the basis of statistic values). The computing process device 35 calculates the prediction body weight PWT(β) at each time point after 0 days (3=1, 2, . . . ) in future in accordance with the combination of the sign (positive or negative) of the tilt α of the linear approximation line A and the result of determination of the magnitude relations as follows.

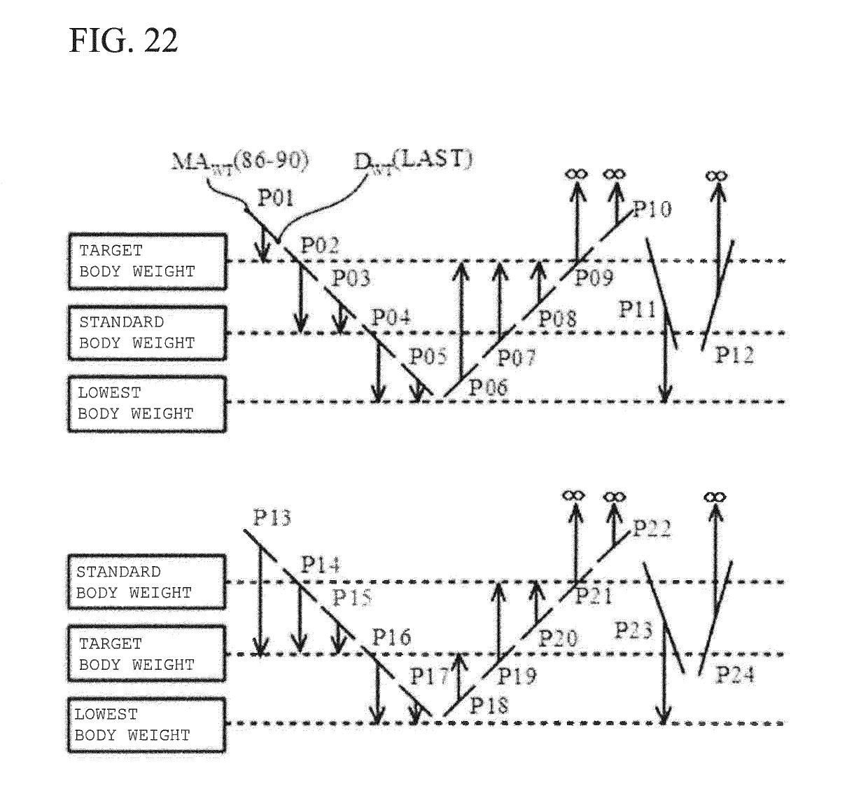

a4. The case where the sign of the tilt α is negative, and average value MA_{WT}(86-90)>data D_{ST}(LAST)>target body weight>standard body weight (the case of case P01 in FIG. 22)

In this case, the computing process device 35 sets the start point of the body weight prediction line A″ on the time axis as the data D_{WT}(LAST), and sets the value after β days in the body weight prediction line A″ as the prediction body weight PWT(β). After the body weight prediction line A″ reaches the target body weight, the computing process device 35 makes the prediction body weight PWT(β) converge to target body weight.

b4. The Case where the Sign of the Tilt α is Negative, and Average Value MA_{WT}(86-90)>Target Body Weight>Data D_{WT}(LAST)>Standard Body Weight (the Case of Case P02 in FIG. 22)

In this case, the computing process device 35 sets the start point of the body weight prediction line A″ on the time axis as the data D_{WT}(LAST), and sets the value after β days in the body weight prediction line A″ as the prediction body weight PWT(β). After the body weight prediction line A″ reaches the target body weight, the computing process device 35 makes the prediction body weight PWT(β) converge to standard body weight.

c4. The Case where the Sign of the Tilt α is Negative, and Target Body Weight>Average Value MA_{WT}(86-90)>Data D_{WT}(LAST)>Standard Body Weight (the Case of Case P03 in FIG. 22)

Calculation of the prediction body weight PWT(β) in this case is performed by a procedure similar to that of b4.

d4. The Case where the Sign of the Tilt α is Negative, and Target Body Weight>Average Value MA_{WT}(86-90)>Standard Body Weight>Data D_{WT}(LAST) (the Case of Case P04 in FIG. 22)

In this case, the computing process device 35 sets the start point of the body weight prediction line A″ on the time axis as the data D_{WT}(LAST), and sets the value after 3 days in the body weight prediction line A″ as the prediction body weight PWT(β). After the body weight prediction line A″ reaches a predetermined minimum body weight, the computing process device 35 makes the prediction body weight PWT(β) converge to minimum body weight.

e4. The Case where the Sign of the Tilt α is Negative, and Target Body Weight>Standard Body Weight>Average Value MA_{WT}(86-90)>Data D_{WT}(LAST) (the Case of Case P05 in FIG. 22)

Calculation of the prediction body weight PWT(β) in this case is performed by a procedure similar to that of d4.

f4. The Case where the Sign of the Tilt α is Positive, and Average Value MA_{WT}(86-90)<Data D_{WT}(LAST)<Standard Body Weight<Target Body Weight (the Case of Case P06 in FIG. 22)

In this case, the computing process device 35 sets the start point of the body weight prediction line A″ on the time axis as the data D_{WT}(LAST), and sets the value after 3 days in the body weight prediction line A″ as the prediction body weight PWT(β). After the body weight prediction line A″ reaches the target body weight, the computing process device 35 makes the prediction body weight PWT(β) converge to target body weight.

g4. The Case where the Sign of the Tilt α is Positive, and Average Value MA_{WT}(86-90)<Standard Body Weight<Data D_{WT}(LAST)<Target Body Weight (the Case of Case P07 in FIG. 22)

Calculation of the prediction body weight PWT(β) in this case is performed by a procedure similar to that of f4.

h4. The Case where the Sign of the Tilt α is Positive, and Standard Body Weight<Average Value MA_{WT}(86-90)<Data D_{WT}(LAST)<Target Body Weight (the Case of Case P08 in FIG. 22)

Calculation of the prediction body weight PWT(β) in this case is performed by a procedure similar to that of f4.

i4. The Case where the Sign of the Tilt α is Positive, and Standard Body Weight<Average Value MA_{WT}(86-90)<Target Body Weight<Data D_{WT}(LAST) (the Case of Case P09 in FIG. 22)

In this case, the computing process device 35 sets the value at the time after β days in the body weight prediction line A″ as the prediction body weight PWT(β) in β days without providing a convergence point of the body weight prediction line A″.

j4. The Case where the Sign of the Tilt α is Positive, and Standard Body Weight<Target Body Weight<Average Value MA_{WT}(86-90)<data D_{WT}(LAST) (the case of case P10 in FIG. 22)

Calculation of the prediction body weight PWT(β) in this case is performed by a procedure similar to that of i4.

k4. The Case where the Sign of the Tilt α is Negative, and Average Value MA_{WT}(86-90)>Target Body Weight>Standard Body Weight>Data D_{WT}(LAST) (the Case of Case P11 in FIG. 22)

In this case, the computing process device 35 sets the start point of the body weight prediction line A″ on the time axis as the data D_{WT}(LAST) and sets the value after 3 days in the body weight prediction line A″ as the prediction body weight PWT(β). After the body weight prediction line A″ reaches a predetermined minimum body weight, the computing process device 35 makes the prediction body weight PWT(β) converge to the minimum body weight.

L4. The Case where the Sign of the Tilt α is Positive, and Average Value MA_{WT}(86-90)<Standard Body Weight<Target Body Weight<Data D_{WT}(LAST) (the Case of Case P12 in FIG. 22)

Calculation of the prediction body weight PWT(β) in this case is performed by a procedure similar to that of i4.

m4. The Case where the Sign of the Tilt α is Negative, and Average Value MA_{WT}(86-90)>Data D_{WT}(LAST)>Standard Body Weight>Target Body Weight (the Case of Case P13 in FIG. 22)

In this case, the computing process device 35 sets the start point of the body weight prediction line A″ on the time axis as the data D_{ST}(LAST) and sets the value after 0 days in the body weight prediction line A″ as the prediction body weight PWT(β). After the body weight prediction line A″ reaches the target body weight, the computing process device 35 makes the prediction body weight PWT(β) converge to the target body weight.

n4. The Case where the Sign of the Tilt α is Negative, and Average Value MA_{WT}(86-90)>Standard Body Weight>Data D_{WT} (LAST)>Target Body Weight (the Case of Case P14 in FIG. 22)

Calculation of the prediction body weight PWT(β) in this case is performed by a procedure similar to that of m4.

o4. The Case where the Sign of the Tilt α is Negative, and Standard Body Weight>Average Value MA_{WT}(86-90)>Data D_{WT} (LAST)>Target Body Weight (the Case of Case P15 in FIG. 22)

Calculation of the prediction body weight PWT(β) in this case is performed by a procedure similar to that of m4.

p4. The Case where the Sign of the Tilt α is Negative, and Standard Body Weight>Average Value MA_{WT}(86-90)>Target Body Weight>Data D_{ST}(LAST) (the Case of Case P16 in FIG. 22)

In this case, the computing process device 35 sets the start point of the body weight prediction line A″ on the time axis as the data D_{WT}(LAST) and sets the value after β days in the body weight prediction line A″ as the prediction body weight PWT(β). After the body weight prediction line A″ reaches the predetermined minimum body weight, the computing process device 35 makes the prediction body weight PWT(β) converge to the minimum body weight.

q4. The Case where the Sign of the Tilt α is Negative, and Standard Body Weight>Target Body Weight>Average Value MA_{WT}(86-90)>Data D_{WT}(LAST) (the Case of Case P17 in FIG. 22)

Calculation of the prediction body weight PWT(β) in this case is performed by a procedure similar to that of p4.

r4. The Case where the Sign of the Tilt α is Positive, and Average Value MA_{WT}(86-90)<Data D_{T}(LAST)<Target Body Weight<Standard Body Weight (the Case of Case P18 in FIG. 22)

In this case, the computing process device 35 sets the start point of the body weight prediction line A″ on the time axis as the data D_{WT}(LAST), and sets the value after β days in the body weight prediction line A″ as the prediction body weight PWT(β). After the body weight prediction line A″ reaches the target body weight, the computing process device 35 makes the prediction body weight PWT(β) converge to target body weight.

s4. The Case where the Sign of the Tilt α is Positive, and Average Value MA_{WT}(86-90)<Target Body Weight<Data D_{WT}(LAST)<Standard Body Weight (the Case of Case P19 in FIG. 22)

In this case, the computing process device 35 sets the start point of the body weight prediction line A″ on the time axis as the data D_{WT}(LAST), and sets the value after β days in the body weight prediction line A″ as the prediction body weight PWT(β). After the body weight prediction line A″ reaches the standard body weight, the computing process device 35 makes the prediction body weight PWT(β) converge to standard body weight.

t4. The Case where the Sign of the Tilt α is Positive, and Target Body Weight<Average Value MA_{WT}(86-90)<Data D_{WT}(LAST)<Standard Body Weight (the Case of Case P20 in FIG. 22)

Calculation of the prediction body weight PWT(β) in this case is performed by a procedure similar to that of s4.

u4. The Case where the Sign of the Tilt α is Positive, and Target Body Weight<Average Value MA_{WT}(86-90)<Standard Body Weight<Data D_{WT}(LAST) (the Case of Case P21 in FIG. 22)

In this case, the computing process device 35 sets the value at the time after β days in the body weight prediction line A″ as the prediction body weight PWT(β) in 0 days without providing a conversion point of the body weight prediction line A″.

v4. The Case where the Sign of the Tilt α is Positive, and Target Body Weight<Standard Body Weight<Average Value MA_{WT}(86-90)<Data D_{ST}(LAST) (the Case of Case P22 in FIG. 22)

Calculation of the prediction body weight PWT(β) in this case is performed by a procedure similar to that of u4.

w4. The Case where the Sign of the Tilt α is Negative, and Average Value MA_{WT}(86-90)>Standard Body Weight>Target Body Weight>Data D_{WT}(LAST) (the Case of Case P23 in FIG. 22)

In this case, the computing process device 35 sets the start point of the body weight prediction line A″ on the time axis as the data D_{WT}(LAST) and sets the value after β days in the body weight prediction line A″ as the prediction body weight PWT(β). After the body weight prediction line A″ reaches a predetermined minimum body weight, the computing process device 35 makes the prediction body weight PWT(β) converge to the minimum body weight.

x4. The Case where the Sign of the Tilt α is Positive, and Average Value MA_{WT}(86-90)<Target Body Weight<Standard Body Weight<Data D_{WT}(LAST) (the Case of Case P24 in FIG. 22)

Calculation of the prediction body weight PWT(β) in this case is performed by a procedure similar to that of u4.

In FIG. 17, the computing process device 35 obtains the prediction body weight PWT(β) at each of time points since the present until a prediction termination point t_{END} and, after that, sends a message (HTTP response) including the body weight prediction line AP connecting the prediction body weights PWT(β) and advice ADV1 determined according to the difference between the prediction body weight PWT(β) at the prediction termination point on the body weight prediction line AP and the target body weight to the user terminal 10 (ST09).

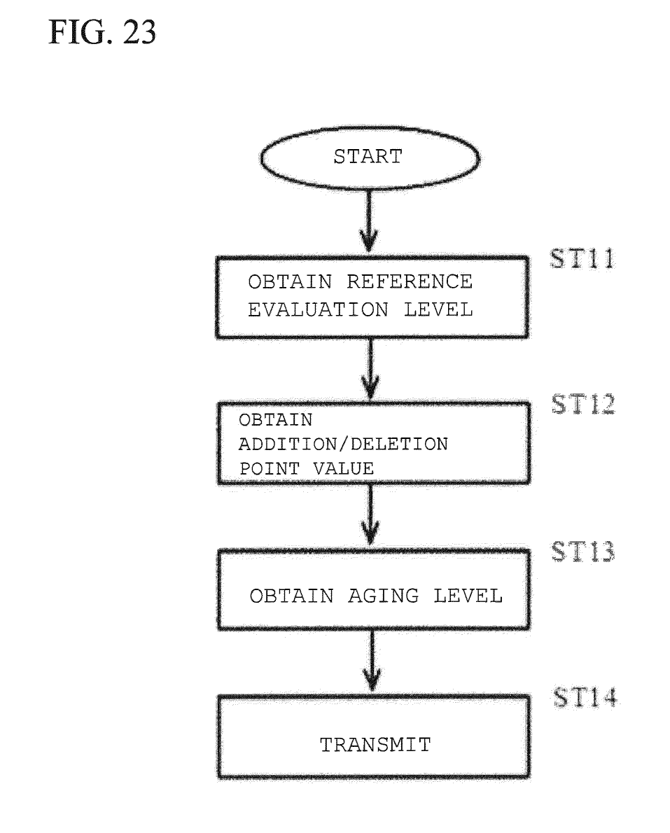

On the other hand, as illustrated in the flowchart of FIG. 23, in the future face picture presenting process, the computing process device 35 selects the evaluation level Lv of anti-aging power and the evaluation level Lv of beauty power in the five kinds of evaluation levels of physical strength, anti-aging power, beauty power, awareness level, and continuity, divides the sum of the two evaluation levels Lv and an average evaluation level L_{AVE} obtained by averaging the evaluation levels Lv of all of kinds by three, and sets the result of division as the reference evaluation level Lv_{BS} (ST11).

The computing process device 35 obtains a gap value GP (GP=|Lv_{MAX}−Lv_{MIN}|) as the difference between the maximum evaluation level Lv_{MAX} and the minimum evaluation level Lv_{MIN} in the five kinds of evaluation levels Lv of physical strength, anti-aging power, beauty power, awareness level, and continuity and, by collating the gap value GP with an addition/deletion point value table TBL4 in the storage device 34, obtains an addition/deletion point value to be acted on the reference evaluation level Lv_{BS} (ST12).

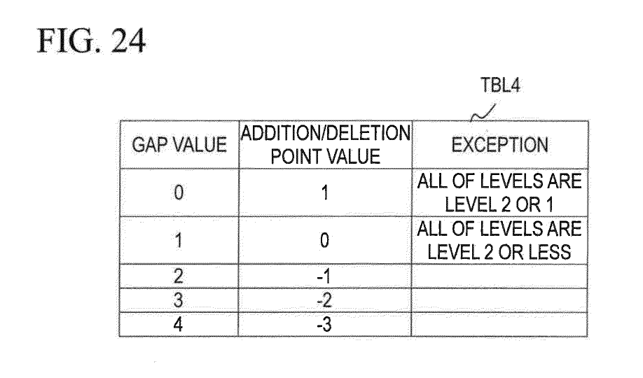

FIG. 24 is a diagram illustrating the data structure of the addition/deletion point value table TBL4. In the table TBL4, the addition/deletion point value in the case where the gap value GP is zero (except for the case where all of the evaluation levels Lv of five kinds are level 1 or 2) is “+1”, the addition/deletion point value in the case where the gap value GP is 1 (except for the case where all of the evaluation levels Lv of five kinds are level 2 or less) is “0”, the addition/deletion point value in the case where the gap value GP is 2 is “−1”, the addition/deletion point value in the case where the gap value GP is 3 is “−2”, and the addition/deletion point value in the case where the gap value GP is 4 is “−3”.

In FIG. 23, the computing process device 35 adds the addition/deletion point value to the reference evaluation level Lv_{BS} and sets the addition result as the aging level Lv_{AGING} of the user (ST13). The computing process device 35 sends a message (HTTP response) including the aging level Lv_{AGING} obtained in step ST13 to the user terminal 10 (ST14).

In FIG. 15, the user terminal 10 of the user controls display contents in the two kinds of the future prediction screens SCR11 and SCR12 in accordance with data in the message transmitted from the server apparatus 30. More specifically, when the button BT7, BT8, or BT9 in the picture selection screen SCR9 (FIG. 16) is selected, the user terminal 10 displays the future prediction screen SCR12. As illustrated in FIG. 15, a face picture image PCT of the user selected in the picture selection screen SCR9 (FIG. 16) is displayed in the center of the future prediction screen SCR12. The time axis bar TL is displayed below the face picture image PCT. On the left side of the time axis bar TL, a reproduction button BT10 is displayed. Below the time axis bar TL, characters of “after 5 years”, “after 10 years”, and “after 20 years” are written. Below the characters, two buttons BT12 and BT11 are displayed. The characters “face” are written in the button BT12. The characters “body weight” are written in the button BT11.

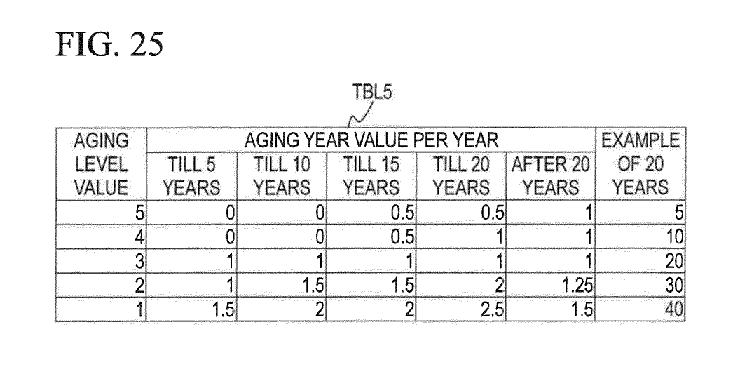

When the user performs an operation of touching the reproduction button BT10 in the future prediction screen SCR12, the user terminal 10 performs a process of making spots and wrinkles appear in the face picture image PCT of the user and expanding/contracting the width in the lateral direction of the face picture image PCT as the pointer PT on the time axis bar TL shifts from the left end (present) to the right end (after 20 years). In the image process, the user terminal 10 extracts an aging year value (value indicative of the degree of aging per year) corresponding to the aging level Lv_{AGING} received from the server apparatus 30 from an aging year value table TBL5 (FIG. 25) in the memory of the user terminal 10, and changes the amount of spots and wrinkles and the expansion/contraction amount in the lateral direction of the face when the pointer PT on the time axis bar TL passes each of the points on the time axis bar TL in accordance with the aging year value and the tilt of the body weight prediction line PA received from the server apparatus 30.

More concretely, for example, in the case where the aging level Lv_{AGING} received from the server apparatus 30 is level 5, the aging year value at present to in five years in the table TBL5 is 0, the aging year value in five to ten years is 0, the aging year value in ten to fifteen years is 0.5, the aging year value in fifteen to twenty years is 0.5, and the aging year value after twenty years is 1. In the image process in this case, the user terminal 10 does not make spots and wrinkles appear in the face picture image PCT until the pointer PT on the time axis bar TL reaches lapse of ten years, makes spots and wrinkles appear in the face picture image PCT after the pointer PT reaches lapse of ten years, and performs an operation of doubling the amount of spots and wrinkles after the pointer PT reaches lapse of twenty years.

For example, in an image process in the case where the sign of the tilt of the body weight prediction line PA received from the server apparatus 30 is positive and the time gradient is 10 kg/year, the user terminal 10 sets a value obtained by multiplying the increase amount per year of body weight with 1.2, which is a conversion coefficient, as an expansion ratio (when the increase amount is 10 kg, 12%), and performs an operation of expanding the face picture image PCT in the lateral direction at the expansion ratio (12%) each time the pointer PT on the time axis bar TL advances by one year. For example, in an image process in the case where the sign of the tilt of the body weight prediction line PA received from the server apparatus 30 is negative and the time gradient is 6 kg/year, the user terminal 10 sets a value obtained by multiplying the increase amount per year of body weight with 1.2, which is a conversion coefficient, as a reduction ratio (when the increase amount is 5 kg, 6%), and performs an operation of reducing the face picture image PCT in the lateral direction at the reduction ratio (6%) each time the pointer PT on the time axis bar advances by one year.

In FIG. 15, when the user performs an operation of touching the button BT11 of “body weight” in the future prediction screen SCR12, the user terminal 10 switches the display screen of the display from the future prediction screen SCR12 to the future prediction screen SCR11. In the center of the future prediction screen SCR11, a graph CHRT indicating the body weight prediction line PA (solid line) and a target body weight line SA (chain line expressing body weight of data D_{GT}) received from the server apparatus 30 is displayed. Below the graph CHRT, characters of “body weight change prediction in 20 years of xx (nickname of the user)” are written. Below it, the prediction body weight PWT(β) (in the example of FIG. 15, 67.5 kg) at the prediction termination point (after 20 years) is displayed. Below it, the advice ADV1 received from the server apparatus 30 (in the example of FIG. 15, “Your effort in the past made you today. Your future is therefore also bright”) is displayed. Below the advice ADV1, the buttons BT12 and BT11 are arranged side by side in the lateral direction. When the user performs an operation of touching the button BT11, the user terminal 10 switches again the display screen of the display from the future prediction screen SCR11 to the future prediction screen SCR12.

The details of the embodiment have been described above. In the embodiment, the following effects are obtained.

First, in the embodiment, the database apparatus 50 stores the multiple kinds of record data D_{ST}, D_{WT}, D_{SL}, D_{SL}, D_{RC}, and D_{UP} recorded with respect to the multiple kinds of record items in the user terminal 10 of each of the users. The server apparatus 30 extracts the multiple kinds of record data D_{ST}, D_{WT}, D_{SL}, D_{ML}, D_{RC}, and Du, recorded during the most-recent first period T1 (T1=7 days) from the multiple kinds of data of the user in the database apparatus 50, obtains the moving average deviations MA_{ST}, MA_{WT}, MA_{SL}, MA_{ML}, MA_{RC}, and MA_{UP} by the kinds of the extracted multiple kinds of record data D_{ST}, D_{WT}, D_{SL}, D_{ML}, D_{RC}, and D_{UP}, by analyzing the obtained multiple kinds of moving average deviations MA_{ST}, MA_{WT}, MA_{SL}, MA_{ML}, MA_{RC}, and MA_{UP} in accordance with a predetermined algorithm, obtains the balance parameters PR indicating the health conditions of the user as the evaluation levels Lv of five kinds of evaluation items of physical strength, anti-aging power, beauty power, awareness level, and continuity, and displays the screen SCR11 including the obtained balance parameters PR as a radar chart in the user terminal 10.

Many of actions taken for maintaining health by a human have both good and bad aspects. For example, exercise is highly recommended from the aspect of improvement in autonomic nerve and improvement in physical strength. However, excessive exercise oxidizes the body and accelerates aging. In the embodiment, the evaluation result of evaluating the health conditions of the user in the five kinds of evaluation items of physical strength, anti-aging power, beauty power, awareness level, and continuity is presented as a radar chart to the user. Therefore, in the embodiment, the user can improve his/her lifestyle habits while paying attention widely to various elements related to his/her health. Thus, according to the embodiment, the awareness to health of the user can be increased to make the user actively work on improvement in his/her lifestyle habits.

Second, in the embodiment, the server apparatus 30 extracts the body weight record data D_{WT} recorded in the second period T2 (T2=90 days) longer than the most-recent first period T1 (T1=seven days) from the body weight record data D_{WT} of the user in the database apparatus 50, obtains the linear approximation line A of the extracted body weight record data D_{WT}, obtains a first weight prediction line A′ obtained by correcting the linear approximation line A with the physical strength coefficient K_{WT} of the magnitude according to the evaluation level Lv of physical strength, obtains the second body weight prediction line A″ by correcting the first body weight prediction line A′ with the basal metabolism coefficient K_{MTB} a of the magnitude according to the combination of the gender and age of the user, and displays the screen SCR12 including the graph CHRT of transition of the future prediction body weight PWT(β) along the tilt α″ of the second body weight prediction line A″ on the user terminal 10 of the user. Therefore, in the embodiment, the user can be encouraged to pay attention to exercise (the number of steps) and body weight as elements exerting influence on the evaluation level Lv of physical strength.

Third, in the embodiment, the server apparatus 30 converts the evaluation levels Lv of the five kinds of the evaluation items of physical strength, anti-aging power, beauty power, awareness level, and continuity to the aging level Lv_{AGING} indicative of the degree of progression of aging of the user and displays the screen SCR11 including a future face picture obtained by performing an image process so that the converted aging level Lv_{AGING} appears as wrinkles and spots of the face and a change in the body weight in the second body weight prediction line A″ appears as extension and contraction of the face onto the face picture PCT of the user, to the user terminal 10 of the user. Therefore, according to the embodiment, the image of the user in the case where the present lifestyle habits are continued can be shown to the user. Thus, according to the embodiment, awareness of improvement in lifestyle habits of the user can be further enhanced.

Although an embodiment of the present invention has been described, the embodiment may be modified as follows.

(1) In the foregoing embodiment, the user terminal 10 uploads the number-of-steps record data D_{ST}, the body weight record data De, the body fat record data D_{FT}, the sleep record data D_{SL}, the application start history record data D_{RC}, and the upload history record data D_{UP} to the database apparatus 50. Since the body fat record data D_{FT} among the above data is not used to calculate the balance parameter PR in the server apparatus 30, it may not be uploaded.
(2) In the foregoing embodiment, the user terminal 10 performs the process, as an image process, of changing the amount of spots and wrinkles on a face and the expansion/contraction amount in the lateral direction when the pointer PT on the time axis bar TL passes each of the points on the time axis bar TL in accordance with the aging year value and the tilt of the body weight prediction line PA. In addition, the expression of the face of the user may be changed. Concretely, the server apparatus 30 sets a value obtained by dividing the sum of the evaluation level Lv of awareness level, the evaluation level Lv of continuity, and the average evaluation level L_{AVE} by three as a facial expression level, and sends a message including the facial expression level together with the aging level Lv_{AGING} to the user terminal 10. In the case where the facial expression level is level 1 or 2, the user terminal 10 processes the face of the user to a sad facial expression. In the case where the facial expression level is level 4 or 5, the user terminal 10 processes the face of the user to a smiling facial expression. In the modification, the awareness to health of the user can be further enhanced.
(3) In step ST8 in the foregoing embodiment, the computing process device 35 may determine whether the prediction body weight PWT(β) converges or not by using a value of 90 days ago in the linear approximation line A instead of the average value MA_{WT}(86-90).

### REFERENCE SIGNS LIST

1 . . . health care system, 10 . . . user terminal, 30 . . . server apparatus, 50 . . . database apparatus, 31, 51 . . . display device, 32, 52 . . . input device, 33, 53 . . . communication device, 34, 54 . . . storage device, 35, 55 . . . computing process device, 36, 56 . . . internal bus

1. A health care system comprising a server apparatus and a database apparatus connected to a user terminal of each user via a network,
wherein the database apparatus stores a plurality of kinds of record data recorded with respect to a plurality of kinds of record items in the user terminal of the each user, and
the server apparatus extracts record data of a plurality of kinds recorded in a most-recent first period in the plurality of kinds of record data of the user in the database apparatus, obtains a moving average deviation by kinds of the extracted plurality of kinds of record data, obtains balance parameters indicating health conditions of the user as evaluation levels of five kinds of evaluation items of physical strength, anti-aging power, beauty power, awareness level, and continuity by analyzing the obtained moving average deviations of the plurality of kinds in accordance with a predetermined algorithm, and displays a screen including the obtained balance parameters as a radar chart in the user terminal.

2. The health care system according to claim 1, wherein the plurality of kinds of record data include body weight record data indicative of body weight of the user, and
the server apparatus extracts the body weight record data recorded in a second period longer than the most-recent first period from the body weight record data of the user in the database apparatus, obtains a linear approximation line of the extracted body weight record data, obtains a first body weight prediction line obtained by correcting the linear approximation line with a physical strength coefficient of a magnitude according to the evaluation level of the physical strength, obtains a second body weight prediction line by correcting the first body weight prediction line with a basal metabolism coefficient of a magnitude according to a combination of gender and age of the user, and displays a screen including a graph of transition of a future prediction body weight along a tilt of the second body weight prediction line in the user terminal of the user.

3. The health care system according to claim 2, wherein the server apparatus converts the evaluation levels of five kinds of evaluation items of physical strength, anti-aging power, beauty power, awareness level, and continuity to an aging level indicative of a degree of progression of aging of the user and displays a screen including a future face image obtained by performing an image process so that the converted aging level appears as wrinkles and spots of a face and a change in body weight in the second body weight prediction line appears as extension and contraction in a lateral direction of the face on a face picture of the user, in the user terminal of the user.
